(19) United States
(12) Patent Application Publication
(10) Pub. No.: US 2009/0085918 A1
(43) Pub. Date: Apr. 2, 2009

(54) METHOD AND DEVICE FOR CREATING MOVIES FROM STILL IMAGE DATA

(76) Inventors: Crawford Adam Hollingworth, Oxford (GB); Jefferey Burleigh Cranford, Brooklyn, NY (US)

Correspondence Address: HOFFMAN WARNICK LLC, 75 STATE STREET, 14TH FLOOR, ALBANY, NY, 12207, US

(21) Appl. No.: 12/127,973

(22) Filed: May 28, 2008

Related U.S. Application Data
(60) Provisional application No. 60/976,879, filed on Oct. 2, 2007.

(51) Int. Cl. G06T 13/00

(52) U.S. Cl. 345/475

(57) ABSTRACT

A method and device for creating movies from still image data in which effects applied in creating the movie are randomly selected to create a novel movie experience each time a movie is created. The movie making method may permit the creation of genre specific movie scenes or whole movies. In this case random selection of effects is not obligatory.

### RELATED APPLICATIONS

This application claims convention priority from a US provisional patent application having application No. 60/976,879, the entire disclosure of which is hereby incorporated by reference.

### FIELD OF THE INVENTION

The present invention is directed towards a method and device for creating movies. More particularly, the present invention relates to a method and device for creating a movie from still images, such as photographs.

### BACKGROUND

The inclusion of still images, such as photographs in presentations is well known. Such a presentation can, for example take the form of slide shows in which a number of still images are consecutively displayed. It is also known to apply image manipulation routines in such slide shows. One such routine is, for example, the application of a zoom effect to highlight certain areas of an image.

Known methods of creating presentations from still images, however, suffer from the disadvantage that they are often recognisable as a simple sequence of still images and that they fail to display a fluency of change and/or consistency of choice viewers are used to from movies.

Methods of making movies from still images are also known. However, such methods require complicated manipulation of the movie on a scene by scene basis and are therefore not easy to use. Even if a user has familiarised himself or herself with such methods the creation of movies using the methods is time consuming and tedious.

The present invention attempts to overcome or at least mitigate this disadvantage.

### SUMMARY OF THE INVENTION

In one aspect of the present invention there is provided a method for creating a movie from one or more still images. In the method a data processing apparatus is caused to randomly select an image effect from a list of predetermined image effects. A movie scene is then created by applying the selected image effect to create a transition between an initial display in which a first portion of the still image is displayed and a later display in which a second portion of the still image is displayed.

The method of this aspect thus bases a parameter of the movie, in this case a particular image effect applied in a movie scene, on a random selection. Doing so ensures that no two movies are the same. This implies to the viewer that a user choice similar to a choice that would be made by a director has been made in the movie creation process and the movie thus obtains a degree of individuality otherwise only known from movies created by human directors. Nevertheless, the user of the method is not forced to invest time and effort into making the choice as the choice is made by the data processing apparatus. The list of predetermined image effects may be a list that comprises all image effects that can be applied or a more limited subsidiary list, as explained in more detail below.

The random selection performed by the data processing apparatus may, for example be a random selection that affords each entry of the list the same probability of being selected or may alternatively be a weighted random selection in which some parameters are more likely to be selected than others. Such weighting could, for example, be based on a known popularity of particular effects and/or on a deemed appropriateness or inappropriateness of effects for use in movies having a predetermined mood, theme, or genre.

Preferably further scenes are created and in this case the data processing apparatus is caused to randomly select a further image effect. Based on this selection a further movie scene can be created. This movie scene may again relate to the display of a portion of a still image in a further initial display and to creating a transition from this further initial display to a further later display by applying the selected further image effect.

The preferred method is thus suitable for creating movies of various durations having a plurality of scenes. The selected image effects may be applied to one and the same still image or to different still images and the created movie may thus relate to image information obtained from one or more still images. The still image or the further still image can be images that are provided by a user and/or stock images.

A list of image effects based on which the random choice is made can include more than one of:
(i) panning from the initial image portion to the further image portion,
(ii) panning from the initial image portion to and beyond the further image portion and returning to the further image portion thereafter,
(iii) zooming within the still image,
(iv) resting on the displayed image portion while applying a camera shake effect to the display of the image portion,
(v) rotating a portion of the still image,
(vi) applying a camera shake effect,
(vii) performing a step wise zooming or panning movement,
(viii) applying a blur effect,
(ix) applying a blur and re-focus effect,
(x) applying a motion blur effect,
(xi) applying a fade in and fade out effect,
(xii) gradually tinting the still image,
(xiii) gradually changing the colour content of the image until the entire image has a predetermined colour, such as white,
(xiv) gradually converting the still image into a negative of itself,
(xv) changing the still image from a colour image to a greyscale image,
(xvi) changing the still image from a greyscale image to a colour image,
(xvii) increasing the contrast of the image,
(xviii) decreasing the contrast of the image,
(xix) applying a graphics overlay over the still image;
(xx) moving the entire still image or a portion thereof from a position in the first display to another position in the second display,
(xxi) combinations of two or more of (i) to (xx), and
(xxii) repeating one or more of (i) to (xx) one or more times.

This list is of course only a list of particularly preferred effects. It is also envisaged that other effects may be included in this list. The image effects help to generate scenes that can have a “home made” feel. The camera shake effect for example can give a feel to the movie that is similar to the feel created by a movie maker using a hand held camera.

The first image portion and the second image portion may be the same. For example if the still image is displayed in one display so that it does not fill the entire display and a ‘zooming’ out effect or a panning effect is applied, then the first and second image portions can be the same and only their size and/or position within the display changes between the first display and the second display.

It is also envisaged that the first image portion and the second image portion are the same and that these first and second image portions change in their colour content. For example, the first image portion may be a colour image that is transformed to gradually take on a colour tint, such as red, blue or green etc for display in the second display, it may be an image that gradually becomes a negative of itself, it may be a greyscale image that is gradually or suddenly transformed into a colour image or vice versa and/or it may be an image with one contrast in the first display and a changed higher or lower contrast in a subsequent display.

The parameters governing the performance of these image effects may be fixed or may alternatively only be determined to within a certain range. For zoom effects, for example, the selection may not determine which amount/depth of zoom is to be applied and/or on which point of the image the zoom feature should focus.

For image rotation effects the amount of rotation may remain undetermined by the selection of the effect. For example, it may be left undetermined by the selection if a slight rotation is intended, for example a rotation by a value of less than 90 degrees or if a larger rotation (e.g. a rotation between 90 degrees and 360 degrees) or even a spin rotation of more than 360 degrees is to be performed. Alternatively, the list of image effects may comprise three entries relating to image rotation, rather than just a single entry as shown above. One such entry may for example relate to ‘slight’ image rotation of up to 90 degrees, another entry may relate to larger image rotation of between 90 degrees and 360 degrees and a third entry may relate to a spin rotation of more than 360 degrees. The actual number of degrees by which the image is rotated may be specified in this selection or may alternatively remain undetermined by the random selection and its determination may be left to other possibly later steps of the method.

Different panning effects may also be applied. Such panning effects may, for example, include panning between a small part of the image and another small part of the image. This includes panning between random points in the still image to provide a shake effect, a panning back and forth between two or more points in the still image and/or panning back and forth between such points while pausing for a brief period on one or more of the points.

It is entirely in conformity with the invention and in some cases even preferred if two or more of the above discussed image effects are combined. It can, for example, be envisaged that an image is rotated onto the display while being zoomed so as to increase in size, that an image slowly loses contrast while disappearing/being zoomed out etc.

The quality of the movie may be improved if it focuses on features of particular interest in the image or on features of particular importance to the human user of the method. The method may thus further comprise the step of receiving an indication from a user of the location of a focal point in the still image. This focal point represents the feature of interest or the feature of particular importance. One or both of the first and second portions of the still image that are to be displayed may then be chosen from the still image so that it/they surround and are centred on the focal point.

A user may wish to specify two such focal points and in this case two indications of the location of focal points in the still image are received. The first portion is then defined to surround and be centred on one of the focal points. The second portion is then defined to surround and be centred on the other one of the focal points.

It has been recognised that the random selection of an image effect for the creation of a movie scene is not only advantageous for movie scenes that focus on a single still image but also for movie scenes that deal with more than one still image, for example, movie scenes that deal with transitions between two images. Thus, in accordance with another aspect of the present invention there is provided a method for creating a movie from one or more still images that comprises causing a data processing apparatus to randomly select an image effect from a list of predetermined image effects and creating a movie scene in which a portion of a first still image is displayed in an initial display and in which a portion of a second still image is displayed in a later display by applying the selected image effect to create a transition between the initial display and the later display. The portion of the first and second still images can be all of the respective still image or part of it.

A list of image effects for transitions used in this method based on which the random choice is made can include more than one of:
(i) an image effect in which the portion of the second image zooms in so as to increase in size and settles on the portion of the first image,
(ii) an image effect in which the portion of the second image zooms in so as to increase in size and settles on the portion of the first image with a bouncing effect,
(iii) an image effect in which the second image zooms in so as to increase in size and subsequently zooms out slightly so as to decrease in size when settling on top of the first image,
(iv) an image effect in which the second image zooms in and spins on top of the first image,
(v) an image effect in which the first image is fragmented and scattered so that the first image disappears and/or in which a fragmented second image appears and in which the fragments of the second image are combined to form the second image,
(vi) an image effect as in (v) and wherein the fragmented and scattered pieces come together in a spinning action,
(vii) an image effect in which the second image is fragmented into a scrambled puzzle and wherein the second image is created by a rearranging of the fragmented pieces,
(viii) an image effect where the first image fades away to reveal the second image,
(ix) an image effect where the first image fades to a predetermined colour, such as white or black, and then fades away to reveal the second image,
(x) an image effect in which the first image breaks into pieces and in which the pieces subsequently fade away,
(xi) an image effect in which the second image is revealed by displaying a part or parts of the second image in a patterned mask, such as a circular mask, a square mask, an amoebic mask, a linear mask, a grid mask, an animated square mask or a snowflake pattern mask within the first image, wherein the patterned mask increases in size until the second image is revealed,
(xii) an image effect in which the second image spins into place,
(xiii) an image effect in which the second image appears to push the first image out of the way,
(xiv) an image effect in which the second image fades in on top of the first image, and
(xv) an image effect which creates the impression of liquid or metallic liquid forming on top of the first image and then dries to revel the second image.

The user may again be requested to specify a focal point in one of the first and the second image. The image portion of the first or second image chosen that comprises the focal point is defined to surround and be centred on the focal point. A user may define one focal point in each of the two images and the portions of the first and second images that are to be displayed in the movie scene are defined as surrounding and being centred on the respective focal points. If a user fails to define focal points required by the selected image effect, then the method may automatically determine all focal points that are required for the application of the image effect.

By focussing some of the image effects applied on focal points specified by the user the method ensures that the movie is sensitive to the regions of the images important to the user. The movie can thus be said to be sensitive to the content of the images.

In a preferred method the user is allowed to select or indicate a mood, theme, or genre for the movie. In this case a corresponding indication is received from the user. The list of predetermined image effects from which the random selection is made may then not comprise all image effects that could possibly be applied but rather only part of a list of all possible effects. In this case the list of predetermined image effects does not comprise image effects that are deemed unsuitable for use in a movie having the mood, theme, or genre indicated by the user. The remaining image effects may be displayed to the user by way of suggestion of suitable image effects. The user may then be permitted or even requested to further limit the list of suggested image effects so that the movie only comprises those effects desired by the user. The random selection is then made based on the further limited list of image effects. This random selection may randomly attribute an image effect to each movie scene.

Allowing the user to specify a method or theme renders the method content sensitive and ensures that the image effects selected are suitable for the intended occasion. Automated movie creation methods providing such a user friendly way of rendering the movie creation process content sensitive are to our knowledge not known.

It will be appreciated that the performance or look of each image effect may be governed by one or more parameters. It is further envisaged that the actual parameter(s) used when applying the image effect in the movie creation process is also randomly selected to further increase the individual nature of the movie. This random selection may be made from respective one or more predetermined ranges of the parameters. This of course applies not only to image effects applied within a single image but also to image effects applied to transitions between two images, such as transitions mentioned above.

This has been recognised as being advantageous in its own right and according to another aspect of the present invention there is provided a method for creating a movie from one or more still images comprising selecting an image effect and causing a data processing apparatus to randomly select one or more parameters associated with the selected image effect from respective one or more predetermined ranges of parameters. A movie scene is then created in which a first portion of the still image is displayed in an initial display and in which a second portion of the still image is displayed in a later display by applying the selected image effect based on a selected parameter to create a transition between the initial display and the later display.

This advantage of course also extends to transitions between two images and according to another aspect of the present invention there is provided a method for creating a movie from one or more still images comprising selecting an image effect and causing a data processing apparatus to randomly select one or more parameters associated with the selected image effect from respective one or more predetermined ranges of parameters. A movie scene is then created in which a portion of a first still image is displayed in an initial display and in which a portion of a second still image is displayed in a later display by applying the selected image effect based on such a randomly selected parameter to create a transition between the initial display the later display.

The methods may again comprise receiving an indication from a user regarding mood, theme, or genre for the movie. One or more of the one or more predetermined ranges of parameters may be sub-ranges of respective ranges of possible parameters. In this case the sub-ranges exclude parameters that are deemed unsuitable for use in a movie having the mood, theme, or genre indicated by the user. The preferred methods thus again allow tailoring of the movie to a mood specified by the user. One or more of these sub-ranges of the range of possible parameters may be associated with moods, themes, or genres. In this case the step of randomly selecting an operating parameter comprises randomly selecting an operating parameter from the sub-ranges of operating parameters associated with the mood, theme, or genre indicated by the user.

Indicating a mood, theme, or genre for selecting operating parameters for the image effects can ensure that two or more image effects are in harmony with each other when applied together in a movie.

A preferred method comprises suggesting movie parameters based on a previously received indication of a user choice. The user may be allowed a degree of freedom for altering the suggested movie parameters. This degree of freedom may be allowed to be changed by the user. The user can thus choose how much of the work performed by a human director he or she wishes to undertake. The remainder of the work can then be performed by the method.

Preferred methods also provide methods for applying image effects to text provided by a user. In such methods the data processing apparatus is caused to randomly select a text effect type from a list of predetermined text effect types. A text effect is then created by applying the selected text effect type to a part or all of text received from a user or to stock text. The text effect is then overlaid on to a scene of the movie. The selected text effect type may be applied to a single letter of the text, separate words of the text or to the entire text. Text effect types may be associated with one or more moods, themes, or genres and selection of a text effect type is only allowed if that text effect type is associated with the same mood, theme, or genre as that indicated by the user.

The list of predetermined text effects types may include more than one of:

(i) rotating letters of the text, groups of letters of the text or the entire text,

(ii) moving letters of the text, groups of letters of the text or the entire text across a display area,

(iii) moving text to a predetermined position within the display area from an edge of the display area, for example the top edge or the left edge, one letter at a time, in groups of letters or all of the text,

(iv) revealing the individual letters of a text or groups of those letters, one at a time by fading them in,

(v) displaying a text or words or letters of the text at a random position or at random positions in the display and subsequently moving it or them to a predetermined position so as to display the text in the predetermined position,

(vi) displaying a text or words or letters of the text at a random position or at random positions in the display and subsequently moving it or them to a predetermined position so as to display the text in the predetermined position while applying a spinning motion;

(vii) shrinking or expanding a displayed text,

(viii) bouncing text across the display area,

(ix) simulating snow fall on the display area, wherein the letters of the text represent snow flakes and leading to a display of the text on the display area,

(x) causing letters, words or the entire text to appear with a sparkle or light beam effect,

(xi) causing letters to roll, tumble or slide on to the display from a side, the top or the bottom of the display,

(xii) effect (xi) while letters bump into each other,

(xiii) causing letters to disappear in a simulation of an explosion,

(xiv) causing letters to disappear in a simulation of an explosion into points of light,

(xv) revealing letters by decreasing or increasing their size until they have a predetermined size,

(xvi) causing letters to disappear by decreasing or increasing their size from a predetermined size

(xvii) causing letters, words or the entire text to shift in from a side, the top or the bottom of the display and to bounce at or off a predetermined position, and

(xviii) a combination of one or more of (i) to (xvii).

Text effect type may also comprise a range of possible operating parameters. In this case one or more sub-ranges of the range of possible operating parameters can be associated with one or more moods, themes, or genres. An operating parameter associated with the selected text effect type can then be randomly selected from those sub-ranges of the range of possible operating parameters that are associated with the mood, theme, or genre indicated by the user.

The method is most preferably implemented in software.

The present invention is not limited to methods and also extends to devices. According to another aspect of the present invention there is provided a device for creating a movie from one or more still images. The device comprises a collection of data processing stages, wherein each data processing stage is arranged for applying an associated image effect to image data, a selector for randomly selecting a data processing stage from the collection of data processing stages and an image data processor arranged to apply the selected data processing stage to still image data to create a movie scene. Each data processing stage may take the form of a programming construct, such as a programmed method.

The collection of data processing methods/stages and the image data processor may be provided in a single data processing unit or in different data processing units. The data device of the above aspect may thus be implemented in a single data processing apparatus, such as a home computer, or may alternatively be implemented on a data processing system remote from a user's computer, such as on a server or on several servers.

The collection of data processing stages may include more than one of:
a) a stage arranged to sequentially display portions of the still image so as to simulate a panning between image portions,
b) a stage arranged to sequentially display portions of the still image so as to simulate a panning from the initial image portion to and beyond the further image portion and returning to the further image portion thereafter,
c) a stage arranged to display all of the still image in a first position in a first display and all of the still image in a second position in a second display,
d) a stage arranged to sequentially display portions of the still image so as to simulate a zooming within the still image,
e) a stage arranged to sequentially display portions of the still image so as to simulate resting on the scene with an unsteady camera,
f) a stage arranged to sequentially display a portion of the still image so as to rotate the portion in the display,
g) a stage arranged to sequentially display portions of the still image so as to simulate a camera shake effect,
h) a stage arranged to sequentially display portions of the still image so as to simulate a step wise zooming or panning movement,
i) a stage arranged to sequentially display a portion of the still image while increasing the amount of blur of the portion,
j) a stage arranged to sequentially display a portion of the still image while first increasing and thereafter reducing the amount of blur of the portion,
k) a stage arranged to sequentially display a portion of the still image while changing the displayed portions in a manner that simulates a motion blur effect,
l) a stage arranged to sequentially display a portion or all of the still image while gradually increasing the amount of a particular colour, for example red, contained in the portions so as to tint the image,
m) a stage arranged to sequentially display a portion or all of the still image while gradually altering the colour content of the portion or all of the still image until the portion or all of the still image comprises only a single colour, for example white,
n) a stage arranged to sequentially display a portion or all of the still image while gradually converting the portion or all of the still image into a negative of itself,
o) a stage arranged to sequentially display a portion or all of the still image while changing the portion or all of the still image from a colour image to a greyscale image,
p) a stage arranged to sequentially display a portion or all of the still image while changing the portion or all of the still image from a greyscale image to a colour image,
q) a stage arranged to sequentially display a portion or all of the still image while increasing the contrast of the portion or all of the still image,
r) a stage arranged to sequentially display a portion or all of the still image while decreasing the contrast of the portion or all of the still image,
s) a stage arranged to a portion of a still image while applying or moving an overlay feature to the portion of the still image;
t) a stage arranged to sequentially display a portion or all of the still image while gradually fading a portion of a still image out and thereafter fading the portion in,
u) a stage arranged to sequentially display a portion or all of the still image so as to generate an effect that is a combination of two or more of the effects generated by the stages of a) to t), and
v) a stage arranged create an effect that is a repetition of the effects generated by one or more of the stages of a) to t).

The device may further comprise a receiver for receiving an indication from a user of the location of a focal point in the still image to allow the user to define such a focal point. A selected data processing stage may be arranged to cause the image data processor to apply the selected data processing stage to a portion of the still image that surrounds and is centred on the location of a focal point received with an indication from a user.

A receiver for receiving an indication from a user of a mood, theme, or genre for the movie may further be provided in the apparatus. Each data processing stage can comprise an indication of one or more moods, themes, or genres for which the data processing stage is suited. In this case the random selector is arranged not to select data processing stages that do not have an indication corresponding to a received indication of a desired mood, theme, or genre

One or more parameters can be associated with a data processing stage. In this case the random selector may further be arranged to randomly select from respective one or more of the predetermined ranges of parameters.

This has been recognised as being advantageous in its own right and according to yet another aspect of the present invention there is provided a device for creating a movie from one or more still images. This device comprises a data processing stage arranged for applying an associated image effect to still image data, a selector for randomly selecting one or more parameters associated with the data processing stage from respective one or more predetermined ranges of parameters and an image data processor arranged to apply the data processing stage based on the selected parameters to still image data to create a movie scene.

A receiver for receiving an indication from a user regarding a mood, theme, or genre for the movie may further be provided. The one or more predetermined ranges of parameters can comprise sub-ranges, wherein each sub-range comprises an indication of one or more themes, moods or genres for which the sub-range is suited. In this case the random selector is arranged not to select sub-ranges of a predetermined range of parameters that do not comprise an indication of a mood, theme or genre corresponding to an indication of a theme, mood or genre received in a user indication.

The device may further comprise a parameter suggester arranged to suggest movie parameters based on received indications of previous user choices. A limiter arranged to limit the degree of freedom available for altering the suggested movie parameters may also be provided. Such a limiter can be arranged for receiving an indication of the degree to which the freedom to alter the movie parameters is to be limited and further to change the degree of freedom based on a the received indication.

The device may further be capable of providing text image effects. For this purpose a collection of text data processing stages may be provided. Each such text data processing stage is arranged for applying an associated image text effect to text data. The selector is further arranged to randomly select a text data processing stage from the collection of text data processing stages. The image data processor applies the selected text data processing stage to text data to create a text image effect and to overlay the text image effect on to a scene of the movie. The collection of text data processing stages can comprise one or more text data processing stages that are arranged to cause the image data processor in use to act on an independent letter of a text. Preferably, text data processing stages arranged to generate the above mentioned text effects are provided.

A receiver may be provided in the device for receiving a user input indicating a theme, mood or genre for the movie. Each text data processing stage may comprise an indication of one or more moods, themes or genres for which the text data processing stage is suited. In this case the selector is arranged not to select a text data processing stage that is not associated with an indication of a suitable mood, theme or genre corresponding to the indication of mood, theme or genre received from the user.

A text data processing stage can comprise a range of possible operating parameters, the range of possible operating parameters comprising one or more sub-ranges. Each such sub-range comprises an indication of one or more moods, themes or genres for which the sub-range is suited. The selector is then arranged not to select a sub-range of parameters that is not associated with an indication of a suitable mood, theme or genre that corresponds to a received indication of mood, theme or genre.

The inventors have realised that users are experienced in distinguishing film or movie material according to the movie's genre. A method of creating a movie from still images that allows the user to associate the movie with a particular movie genre is therefore deemed particularly effective in transforming existing user expectations regarding a desired format of the movie into a finished movie product (or at least into an automatically generated sample movie that can later be edited by the user) that has the look and feel expected by the user. The inventors have realised that, by providing a method that permits limiting the range of possible parameters available for creating the movie from the still image data in accordance with a desired movie genre a movie can be created that likely conforms to the user's expectations.

This has been recognised as being advantageous in its own right and in accordance with another aspect of the present invention there is provided a method for creating a movie from one or more still images comprising selecting within or receiving at a data processing apparatus an indication of a movie genre. The data processing apparatus is then used to automatically create a movie scene by applying to still image data one or more of an image transition effect suitable for use with the selected or indicated movie genre and an image effect suitable for use with the selected or indicated movie genre.

The selection of the desired movie genre can be made by the user directly, for example if the user operates a personal computer arranged to perform the method. A relevant indication of the desired genre can alternately be received at the data processing apparatus, for example via a data transmission medium if the method is performed in a server connected to a network such as the internet.

The data processing apparatus may be arranged to be able to base movie scenes on a number of image transition effects or image effects made available for this purpose. Some of these effects may, however, not be suitable for use in creating a movie scene in accordance with a particular genre (or indeed in accordance with more than one genre). Other available effects may only be suitable for such use if a parameter or parameters governing the operation of such effects are within a range or ranges suitable for use in creating a movie scene in accordance with one or more genres. In accordance with this aspect of the present invention effects are only applied if they are suitable for the intended use. Thus, effects not suitable for creating a movie scene in the desired genre are not used in creating the particular movie scene. Effects that are only suitable when operated if specific parameters are used are operated based on such suitable parameters. Limiting the application of image transition effects and image effects in one or more of the manners discussed above allows generating movie scenes that are likely to correspond to the user's expectations.

The effects available to the data processing apparatus may be stored in the form of software routines within the data processing apparatus. The data processing apparatus may alternatively simply store a list of effects available on a different data processing apparatus. The data processing apparatus may in this case employ the different data processing apparatus for applying an appropriate effect to the still image data. The data processing apparatus can then simply select the effect to be applied from the list and instruct the further data processing apparatus, for example via a remote link, to apply the selected effect to the still image data. The still image data may be resident on the further data processing apparatus or be transmitted from the data processing apparatus to the further data processing apparatus. Alternatively the further data processing apparatus may transmit a requested software routine suitable for performing the selected effect to the data processing apparatus The data processing apparatus can then apply the effect to the still image data.

One or more of the image effects and image transition effects, preferably all of the image effects and image transition effects, may be associated with one or more particular genres to indicate that the effect is suitable for creating a movie scene in accordance with the associated movie genre. Such association may be stored in the form of association data, such as an association table, in the data processing apparatus.

The aspect of the present invention is of course not limited to creating only a single movie scene. Instead the aspect also encompasses generating a second and further movie scenes according to the indicated genre. When creating further scenes, a further image effect or a further image transition effect associated with the selected or indicated genre may be applied to still image data. The further image effect and/or image transition effect may be selected such that repeated use of the effect within the movie or within a part of the movie is prevented. Such prevention may not be desired for all effects and/or in all movie genres. Preventing the repetition of effects within a movie or within a part of a movie may thus be limited to specific effects and/or genres. Such avoidance of repetition emulates the behaviour of a director intending to avoid overexposure of a viewer to a particular effect.

Effects suitable for use in creating a movie scene in accordance with an indicated movie genre may be selected using a weighted selection method. For this purpose image effects and/or image transition effects may be associated with a maximum desired use indicator or with indicators that indicate the maximum number of times a particular image effect or image transition effect should be used per unit duration of a movie having a particular genre. Thus, for example, a particular effect may be associated with an indicator stating that the effect should not be used more than twice in a particular unit time period, for example 5 seconds, if the selected movie genre is ‘home movie’. The same effect may be associated with a further indicator stating that the effect should desirably not be repeated more than four times on the same unit time period, if the selected movie genre is ‘comedy’. Once a movie genre has been indicated by a user the method can then select an image effects/image transition effect out of all available effects using a weighted selection process, in which effects associated with a high indicator value are more likely to be selected than effects associated with a low indicator value. Performing such a weighted selection step not only ensures that the likelihood of use of a particular image transition effect and/or image effect is less or equal to said maximum desired use, the use of the weighted selection step can also exclude undesired or unsuitable image effects and image transition effects from the selection if the weighting factor associated with the undesired effect and a particular genre is zero or close to zero.

As discussed above, image effects and/or a transition effects may at least be partially defined by an operating parameter having a range, wherein a suitable value for the operating parameter is chosen for the application of the effect to still image data. One or more sub-ranges of said range may not be deemed suitable for use in creating a movie in a predetermined genre. This may, for example, be the case for an operating parameter governing the speed of an effect, for example panning speed in a panning image effect, where minimum and/or maximum speed values achievable can be considered as imbuing the movie with a sense of urgency for sluggishness not deemed appropriate for a selected movie genre. If sub-ranges of an operating parameter range are deemed unsuitable for use in creating a movie in accordance with the genre selected by the user the image effect and/or transition effect is applied to the still image data based on operating parameters that are not within the sub-range.

As discussed above, the application of a particular image effect or image transition effect may not be performed on the data processing apparatus that receives the indication of a desired genre from the user. The above described limiting of the effects available for application to still image data to effects suitable for use in the genre selected by the user and the described limiting of the ranges of the operating parameters used when applying these effects to still image data, however, can still be performed on the data processing apparatus receiving the indication of the desired genre from the user.

The consecutive and/or simultaneous use of two image effects and/or image transition effects. may, for example lead to an undesired mutual cancellation or convolution of the effects created by the two effects. To avoid such complications the data processing apparatus may store information indicating that a first image effect and/or image transition effect should not be applied to still image data at the same time as a second image effect and/or image transition effect is applied to the image data or indeed directly following such an application of the second effect. This can be of particular importance where image effects and transition effects are applied at the same time. It may, for example, be imagined that an image transition effect is arranged to decrease the size of a still image that is to be removed from the display so that the image seems to move away from the observer and to then disappear. The result achieved by this image transition effect would of course be cancelled if an image effect increasing the size of the image was simultaneously applied. To overcome problems of this type image effects and/or image transition effect may be associated with (in)compatibility indicating other image effects and/or transition effect that are incompatible for simultaneous and/or consecutive use. Such (in)compatibility information may be stored in a location separate from code creating the effect when executed. One location for storage of such (in)compatibility information may, for example, be a table comprising other information/indicators relating to the effects, such as for example, the above discussed weighting factors. Alternatively the (in)compatibility information can be stored as part of the code creating the effect when executed, for example as part of header information associated with the code.

It may also be desirable to avoid the simultaneous and/or consecutive use of image effects and/or image transition effect that are known to be demanding in terms of the computational resources required for their performance. Such effects can also be indicated as being incompatible with each other, so that their simultaneous or consecutive use is avoided and the peak computational power requirements on a data processing apparatus imposed by a single movie creating process is limited. While data processing apparatus are expected to be able to provide the required data processing power for a single movie creating process even if peak computational power requirements are not limited in this manner, limiting of peak power requirements is important in cases where computation is nevertheless performed on a data processing apparatus designed to simultaneously perform a plurality of movie creation processes. It will be appreciated that, if a number of computationally demanding processes are performed simultaneously on such an apparatus, then the apparatus' computing speed may be reduced significantly and the apparatus' computational limits may even be reached.

In accordance with another aspect of the present invention there is also provided a method for performing a selection for use in a process of creating a movie from one or more still images comprising selecting within or receiving at a data processing apparatus an indication of a movie genre and limiting one or more of a range of available image effects, a range of available image transition effects, a permissible range of a permissible range of a parameter for the performance of an image effect and a parameter for the performance of a transition effect to a range deemed suitable for use in creating a movie in accordance with the selected or indicated genre.

There is therefore no need to perform the actual image processing steps in the data processing apparatus used for selecting an image effect, an image transition effect or a parameter for the performance of such an effect. The image data processing steps can instead be performed by another data processing apparatus, for example a remotely located data processing apparatus. The method nevertheless preferably comprises the step of creating a movie scene from still image data based on an image effect and/or image transition effect selected from the limited range and/or operated using a parameter selected from a limited parameter range.

An indication may be stored in the data processing apparatus of the suitability of an image effect and/or a transition effect for creating a movie in a predetermined movie genre. An indication may also be stored in the data processing apparatus of the suitability of a sub-range of a parameter range governing the operation of an image effect and/or an image transition effect for use in creating a movie in a predetermined movie genre. Such indications may be stored in the form of a table linking one or more, preferably all of the effects/sub-ranges with one or more, preferably all genres, while at the same time indicating as part of the link whether or not a particular effect/sub-range should be used with the genre it is linked to.

The relevant indication may alternatively be stored in the form of a table in which one or more genres are linked with only those image effects and/or sub-ranges that are suitable for creating a movie scene in that genre.

Further alternatively or additionally the image/image transition effect itself may comprise header information indicating which genres the effect can suitably be used for and/or which sub-ranges of possible operating parameters should be chosen for such use.

According to another aspect of the present invention there is provided a method for performing a selection in a process of creating a movie from one or more still images comprising selecting within or receiving at a data processing apparatus an indication of a movie genre and performing within the data processing apparatus a weighted selection step of one or more of an image effect from a plurality of available image effects, an image transition effect from a plurality of available image transition effects, a parameter for the performance of an image effect from a range of available parameters for the performance of the image effect and a parameter for the performance of an image transition effect from a range of available parameters for the performance of the image transition effect. The selection is weighted so that it is more likely that an effect or parameter suitable for creating a movie scene in accordance with the selected or indicated genre is selected than an effect or parameter not suitable for creating a movie scene in accordance with the selected or indicated genre.

According to another aspect of the present invention there is provided a data processing apparatus arranged to perform a selection, the selection being intended for use in creating a movie scene from still image data. The apparatus is arranged to receive an indication of a movie genre and comprises a selector. The selector is arranged to automatically select one or more of:
an image effect suitable for use in creating a movie scene in accordance with the received indication of movie genre from a plurality of available image effects;
an image transition effect suitable for use in creating a movie scene in accordance with the received indication of movie genre from a plurality of available image transition effects;
a parameter suitable for the performance of an image effect in accordance with the received indication of movie genre from a range of available parameters for the performance of the image effect; and
a parameter suitable for the performance of an image transition effect in accordance with the received indication of movie genre from a range of available parameters for the performance of the image transition effect.

The apparatus preferably further stores information indicating which ones of the available image effects and/or image transition effects are suitable for use in creating a movie in accordance with a predetermined genre or with predetermined genres. The selector is preferably further arranged to select only from image effects and/or image transition effects indicated as being suitable for use in creating a movie scene in accordance with the received indication of a genre.

The apparatus preferably further stores information indicating one or more sub-ranges of the range of available parameters for the performance of the image effect and/or the image transition effect, wherein the indicated sub-ranges are deemed suitable for use in creating a movie in accordance with a predetermined genre or with predetermined genres. The selector is preferably arranged to select the parameter only from a sub-range or sub-ranges indicated as being suitable for creating a movie scene in accordance with the received indication of a genre.

The apparatus may further store information regarding a maximum desired use of one or more of the plurality of available image effects and/or image transition effects for one or more of the available movie genres. The selector is then arranged to perform a weighted selection of an image effect and/or image transition effect. The stored information associated with the received indication of a genre serves to provide weighting factors for use in the weighted selection step.

The present invention is of course not limited to the above apparatus for making a selection. Instead, in accordance with another aspect of the present invention there is provided an apparatus for creating a movie scene from still image data. This apparatus comprises the above discussed apparatus for making a selection and is further arranged to create a movie scene based on the still image data and on an output of the selector.

It will be appreciated that the method is preferably performed in a data processing apparatus that can be remotely accessed by a plurality of users through a network. The method may, for example, be performed on a server connected to the internet. A movie comprising one or more scenes created in accordance with one or more of the above described methods can then be delivered to a data processing device owned by the user via the network. [Crawford: This should hopefully cover your first comment. We have already of course a description of all this further below.]

### BRIEF DESCRIPTION OF THE DRAWINGS

Preferred embodiments of aspects of the present invention will now be described by way of example only and with reference to the accompanying drawings, in which:

FIG. 1 illustrates the structure of a movie maker according to a preferred embodiment;

FIG. 2 shows a flow chart of the data collection stage of the movie making method of the preferred embodiment;

FIG. 3-1 shows a user interface displayed on a user's computer screen to enable the user to select a general occasion to which the movie should relate;

FIG. 3-2 shows a user interface displayed on a user's computer screen to enable the user to select a more specific occasion to which the movie should relate;

FIG. 4 shows a user interface displayed on a user's computer screen for enabling a user to select the length of the movie;

FIG. 5 shows a user interface displayed on a user's computer screen for enabling a user to enter opening and closing messages;

FIG. 6-1 shows a user interface displayed on a user's computer screen for enabling a user to select still images for inclusion in the movie;

FIG. 6-2 shows a user interface displayed on a user's computer screen for enabling a user to provide a caption for display with the still images;

FIG. 7 shows a user interface displayed on a user's computer screen for enabling a user to indicate the location of focal points in the still images;

FIG. 8 shows a user interface displayed on a user's computer screen for enabling a user to adjust suggested movie parameters;

FIG. 9 shows a user interface displayed on a user's computer screen for enabling a user to add a movie countdown and closing credits;

FIG. 10 shows a user interface displayed on a user's computer screen for enabling a user to choose background music for the movie;

FIG. 11 illustrates a data layer structure upon which the movie maker of the preferred embodiment operates when creating a movie;

FIG. 12 is a flow chart illustrating how the movie maker of the preferred embodiment sequentially operates on the input data;

FIG. 13 shows one possible user interface displayed on a user's computer screen for editing a sample movie;

FIG. 14 shows another possible user interface displayed on a user's computer screen for editing a sample movie;

FIG. 15 shows an alternative user interface for the entry of opening and closing messages;

FIG. 16 shows a user interface for the selection of a movie genre on which the movie is to be based;

FIG. 17 shows an alternative user interface for the selection of an occasion to which the movie is to relate;

FIG. 18 shows a table comprising information indicating suitability of image effects for use a number of movie genres;

FIG. 19 shows a table comprising information indicating the maximum number of times an image effects should be used in a part of a movie dependent on movie genre;

FIG. 20 shows a table comprising information regarding maximum and minimum parameter values for the application of image effects to particular movie genres;

FIG. 21 provides an overview of a preferred embodiment relating to the random selection an image effect;

FIG. 22 provides an overview of a preferred embodiment relating to the random selection an image transition effect;

FIG. 23 provides an overview of a preferred embodiment relating to the random selection of one or more parameters associated with an image effect;

FIG. 24 provides an overview of a preferred embodiment relating to the random selection of one or more parameters associated with an image transition effect;

FIG. 25 provides and overview of a preferred embodiment in which a movie scene is created based on a selected movie genre;

FIG. 26 provides an overview of a preferred embodiment in which a range is limited based on a selected movie genre; and

FIG. 27 provides an overview of a preferred embodiment in which a weighted selection step is performed based on a selected movie genre.

### DESCRIPTION OF A PREFERRED EMBODIMENT

### Overall Structure of the Preferred Movie Maker

In the preferred embodiment the method is performed on a server connected to a network, for example to the internet. The method of the preferred embodiment is implemented on the server as an ASP.NET application. The method of the preferred embodiment is thus accessible to and can be initiated by a large number of users. A movie created by the method can be delivered to the user via the network or via other means.

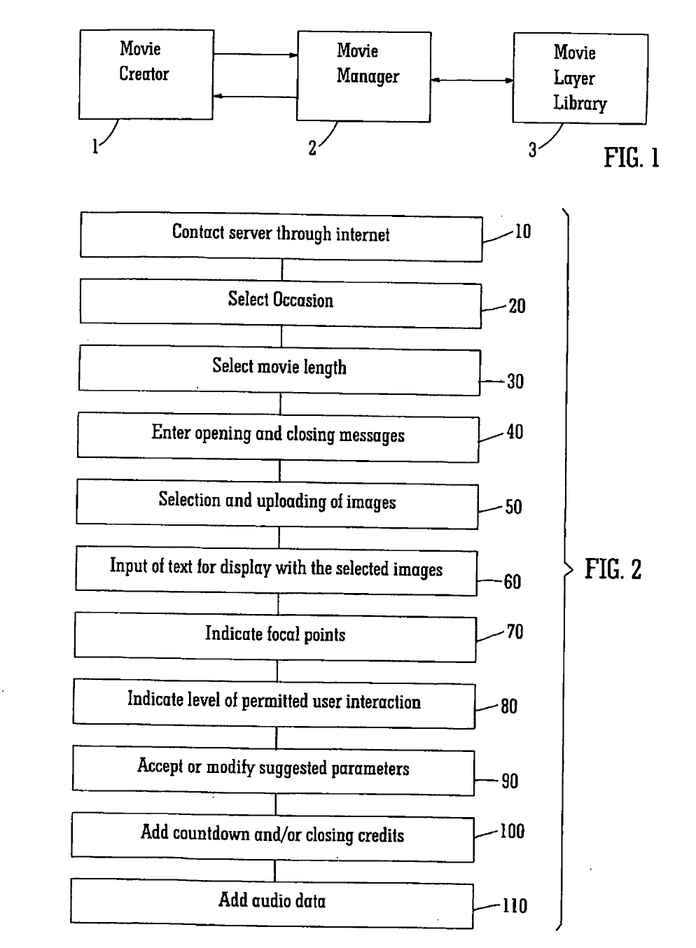

The general structure of the preferred movie maker is shown in FIG. 1. As can be seen from the figure, the movie maker comprises a movie creator unit 1 and a movie manager unit 2.

The movie creator 1 is responsible for the collection of data from a user, for suggesting main parameters on which the creation of the movie could or should be based, for accepting alterations of the selected parameters from the user, for selecting which image effects are to be used in the movie and for applying a degree of randomness to the movie. This application of randomness ensures that no two movies are the same, even if based on the exact same input data. Applying randomness to the movie thus serves to simulate the making of choices in the movie creation process that would otherwise be made by a director. The ‘feel’ this imbues onto the movie is, however, achieved without tedious scene by scene editing as is required in known movie making methods. Data collected by the movie creator 1 comprises still images that are to be included in the movie, coordinates of portions of the images considered by the user as being particularly important (these points will hereinafter be referred to as focal points), text data, sound data etc.

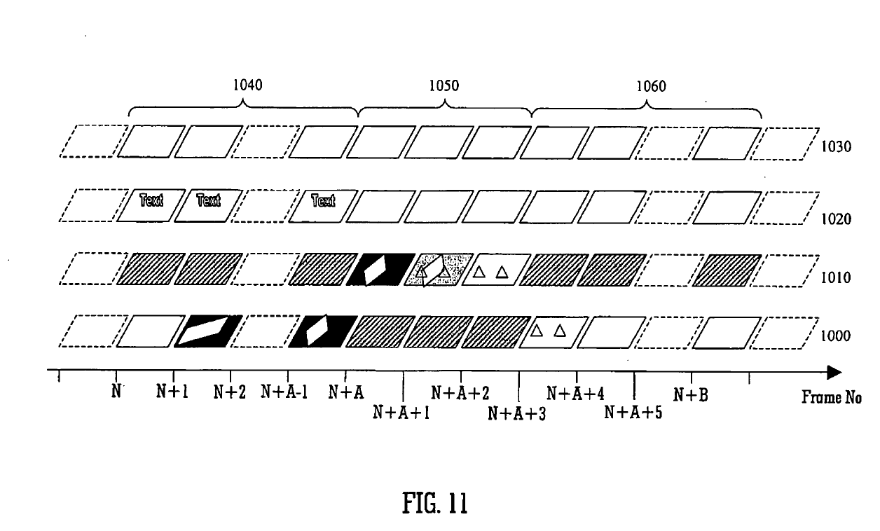

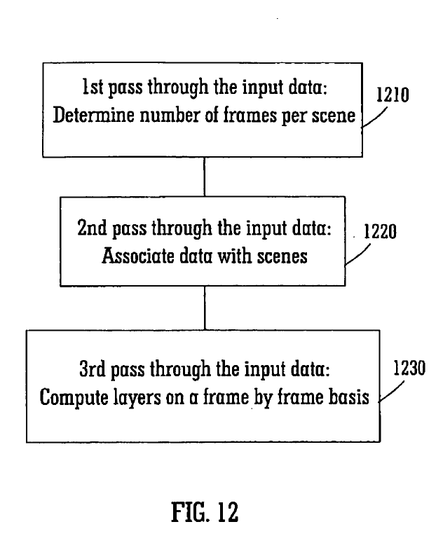

The second unit, the movie manager unit 2, performs the computation required for the creation of the frames of the film based on the input data collected by the movie creator 1 and on the parameters and image effects selected by the movie creator 1. The computation performed by the movie manager 2 is based on image and text effect routines stored in and supplied by a movie effect layer library 3 shown in FIG. 1, when called upon. While the movie creator 1 selects the type of image effect that is to be applied in the film, the movie manager 2 determines the parameters governing the performance of the image effect, as is explained in more detail below. The selection of the effect by the movie creator 1 and/or the selection of the parameters by the movie manager 2 can be random selections from a predetermined list of effects or a predetermined range of parameters, as is described in more detail below. The computational steps performed by the movie manager 2 are explained in more detail below with reference to FIGS. 11 and 12.

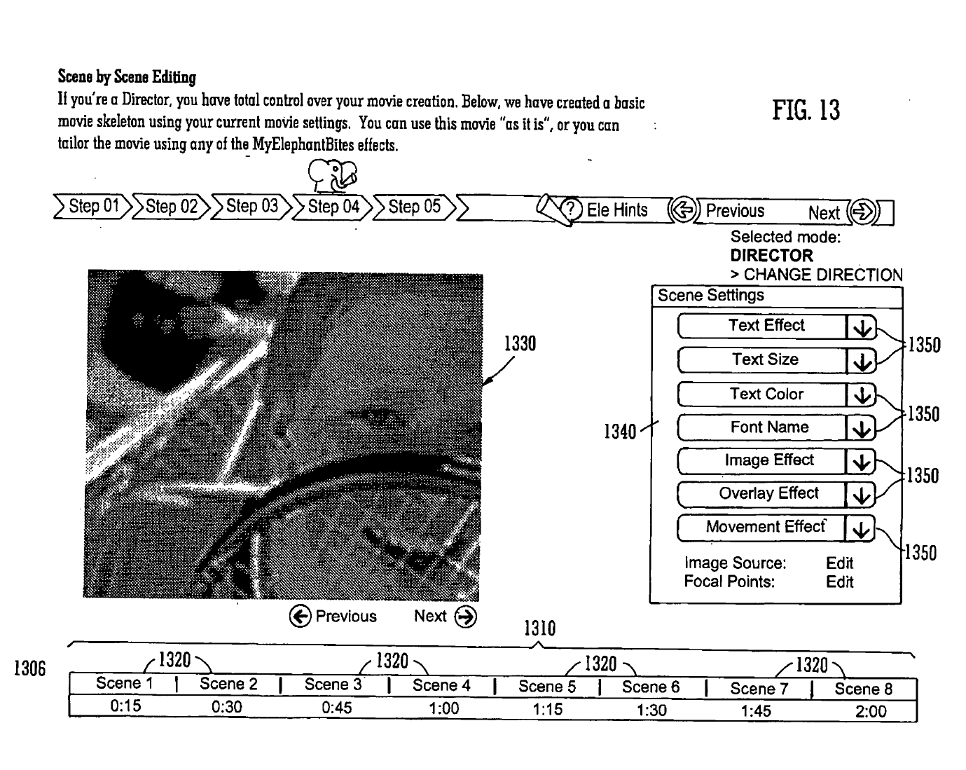

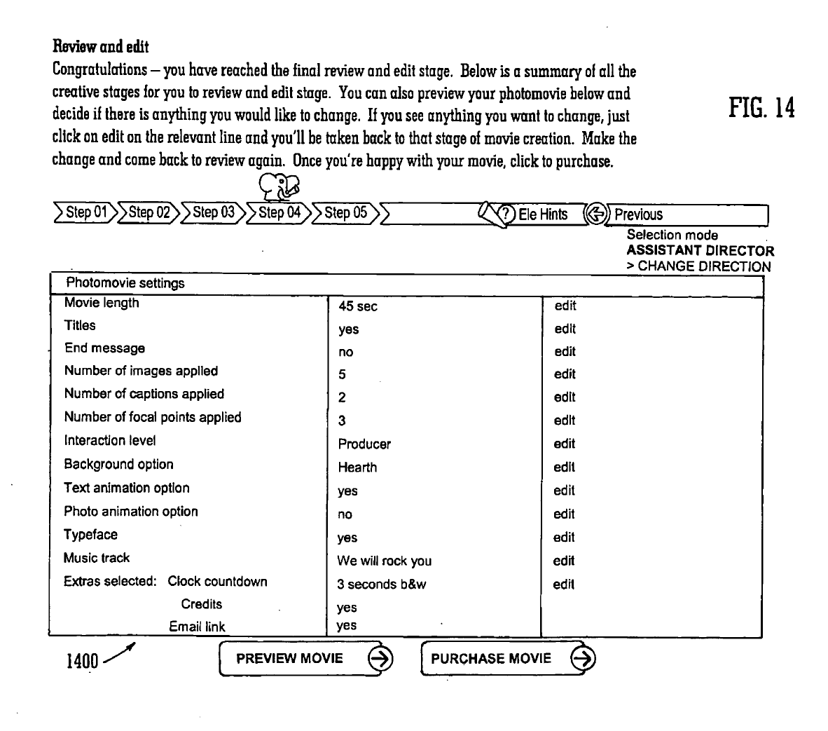

The movie manager 2 returns a sample movie to the movie creator 1 for review by the user. The user is then presented with the opportunity to review the movie and to alter movie parameters as will be described in more detail below with reference to FIGS. 13 and 14. If the user alters movie parameters in the review stage of the movie creation process, then the movie creator 1 again passes the altered parameters to the movie manager 2 in a further iteration step. In response the movie manager 2 generates an altered movie based on the altered movie parameters and again supplies this altered movie to the movie creator 1 for further review by the user. Once the user is satisfied with the movie the movie can be delivered to the user in electronic form, preferably following payment of an appropriate user fee, or in the context of a free trial. The movie creator 1 allows a user to generate sample scenes of the movie based on currently selected input parameters during the data input. For this purpose the movie manager unit 2 can be invoked during data input. The move manager unit 2 then returns two frames of a sample scene to help the user decide whether or not an image effect selected for the creation of the sample scene is appropriate or desirable.

In the following, the respective functions of the movie creator 1 and the movie manager 2 and the interaction between these two units will be described. The description focuses initially on the data collection function of the movie creator 1 with reference to FIGS. 2 to 10. Subsequently a description of the movie creator's image effect and parameter selection function is provided. The function of the movie manager 2 will then be described with reference to FIGS. 11 and 12, followed by a description of the review feature provided by the movie creator 1.

### The Movie Creator

### Data Collection

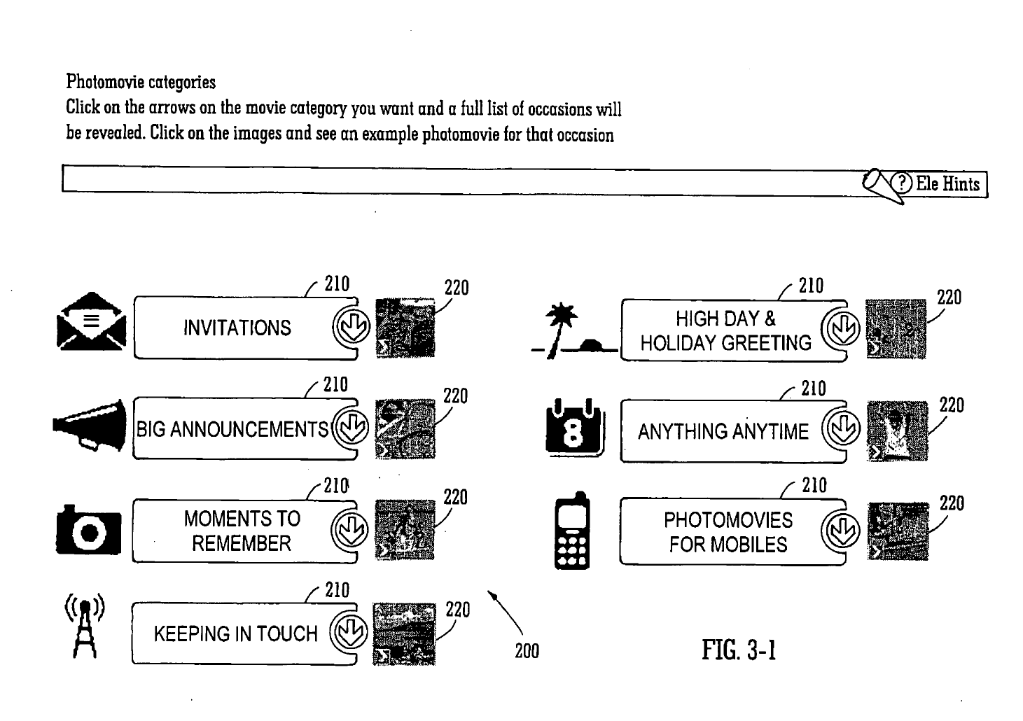

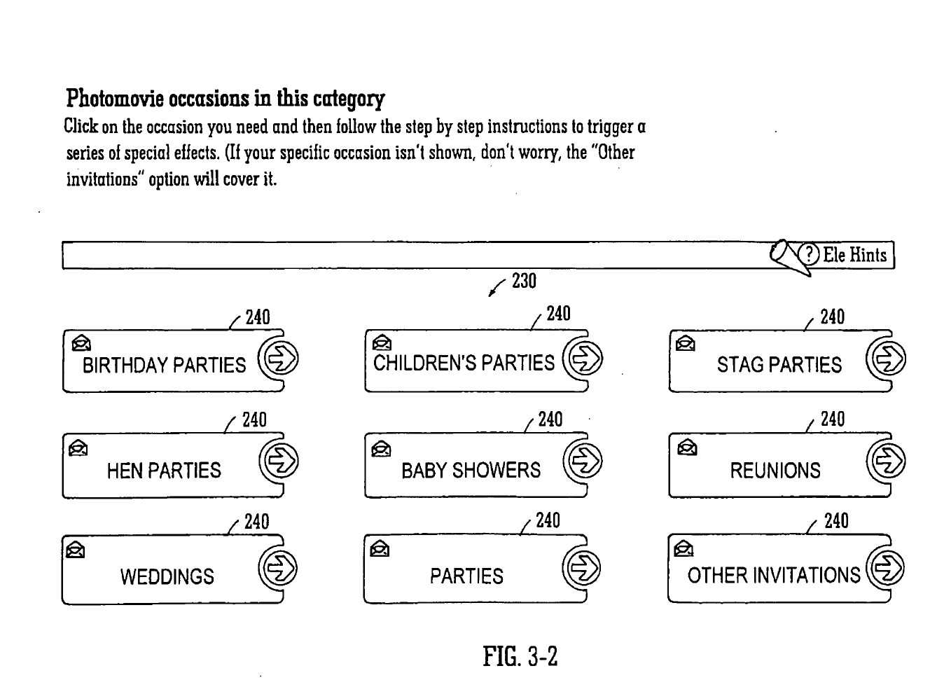

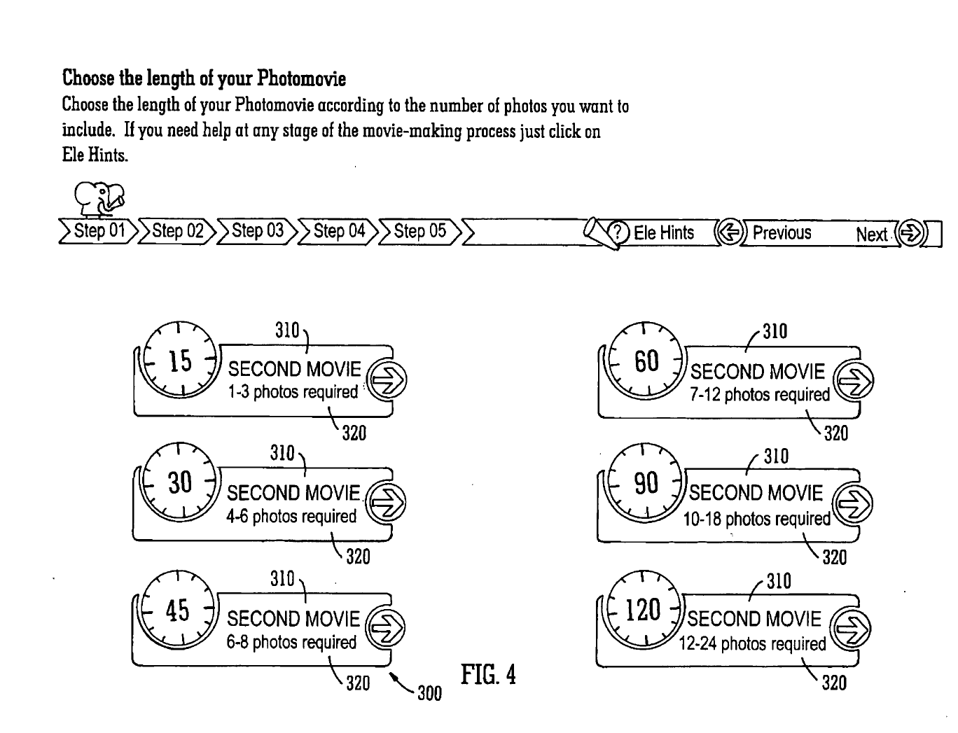

Referring now to FIG. 2, a flow chart illustrating the data collection steps performed by the movie creator 1 is shown. After activation of the movie creator 1 by a user data collection is initiated in step 20. The user is initially presented with a request to indicate the occasion for or theme based on which the movie is to be created. The user interface 200 shown in FIG. 3-1 providing possible general occasions or general themes for selection by a user is displayed on the user's computer for this purpose. The user can then select the appropriate or desired general occasion or theme by activating a related icon 210. The information provided by the user in this step 20 is transmitted to the server and later forms the basis for narrowing the selection of image effects, text effects, and other movie parameters presented to the user as being suitable for inclusion in a movie relating to the indicated occasion or theme. In other words, the general occasion or theme selected by the user is taken to reflect a mood the movie is supposed to have. The movie creator 1 adapts suggestions made to the user and automatic selections to be in harmony with this mood. To provide an indication of the mood associated with each icon 210, the movie creator provides sample movies 220 of the selected type alongside the icon 210.

After the user has selected a particular general occasion or theme the further user interface 230 shown in FIG. 3-2 relating to more specific occasions or themes 240 is displayed on the user's computer. The selection shown in FIG. 3-2 is a selection of specific occasions relating to the general theme of ‘Invitations’. Information indicating which of the specific occasions or themes 240 was chosen by the user is again sent to the server from the user's computer.

In step 30 shown in FIG. 2 the user interface 300 shown in FIG. 4 is displayed on the user's computer screen to allow the user to select the desired length 310 of the movie. Recommendations 320 as to the number of still images or photographs required to adequately fill the selected movie length are also provided. The user will, however, not be bound by these recommendations and is free to deviate from these recommendations at a later stage. Information indicating the user's selection of desired movie length is again sent to the server from the user's computer.

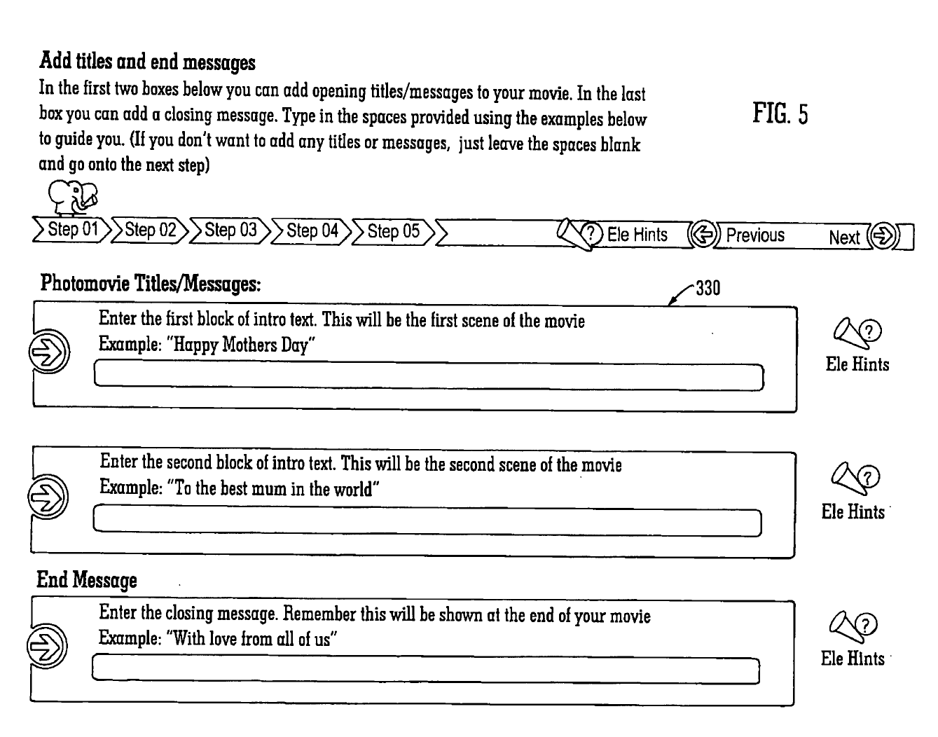

The preferred method also allows the user to provide his or her own opening and closing messages. To enable the user to provide these messages the user interface 330 shown in FIG. 5 is displayed on the user's computer in step 40 of FIG. 2. Information regarding the selected opening and closing messages are transmitted to the server from the user's computer.

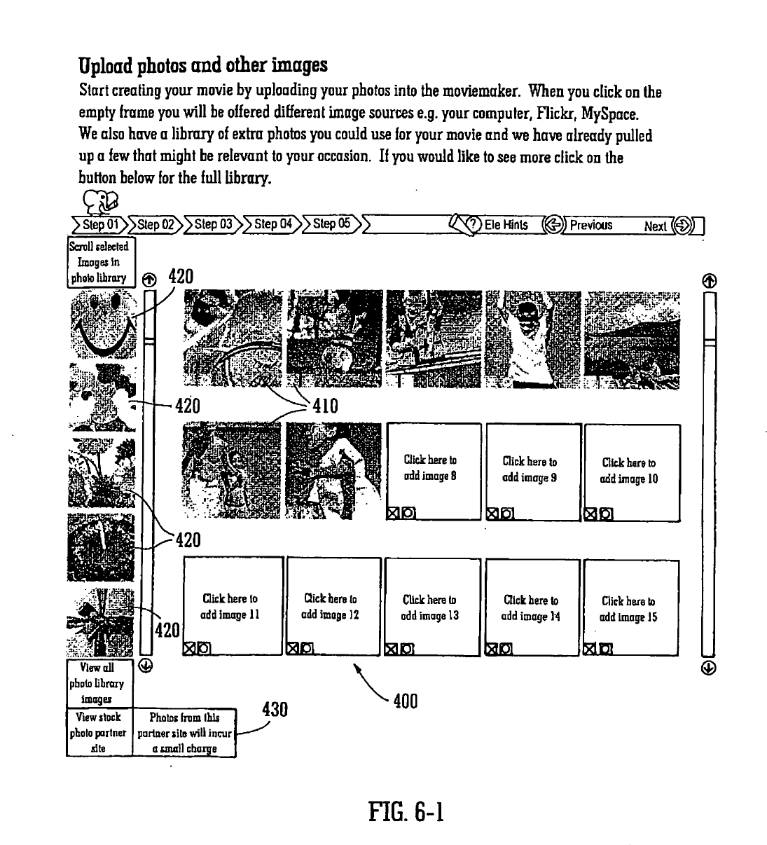

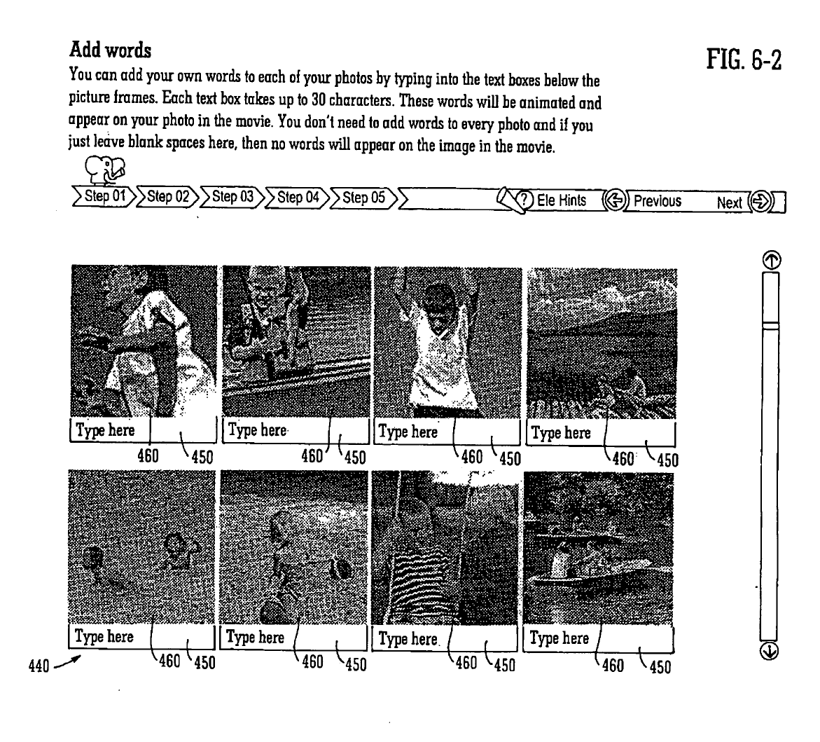

The user is then prompted to indicate which still images or photographs the movie is to be based on in step 50 of FIG. 2. The user interface 400 shown in FIG. 6-1 is displayed on the user's computer screen for this purpose. The user interface 400 comprises a number of display areas 410 that act as user activatable buttons. Initially these fields 410 display a message requesting that the user indicates which still image or photograph he or she wants to use in the movie. An image can be selected for inclusion in the movie by activation of a field/button 410. The selected image is then displayed in the field 410, as is shown in FIG. 6-1. The order in which the images are displayed in the user interface 400 corresponds to the order in which the images will be used in the movie.

As mentioned above, the method recommends a number of images for use in a movie having the length selected by the user. This recommendation is followed in user interface 400 and the number of fields 410 displayed in the user interface 400 corresponds to the maximum number of recommended images. The user is, however, free to add additional images or to reduce the number of images or photographs used by leaving a number of fields 410 blank. As can be seen from FIG. 6-1, the buttons 410 are numbered.

A link to an image library associated with the server is also provided as part of the user interface 400. Through this link a user can select from a number of stock images 420 for inclusion in the movie. A further link 430 to a stock image internet site cooperating with the server is also provided as part of the user interface 400. This link 430 allows the incorporation of further stock images in the movie. The selected images or photographs are uploaded form the user's computer to the server for inclusion in the movie. It is also envisaged that, instead of displaying thumbnails of stock images 420 as part of the interface 420 this user interface 420 could simply display a hyperlink to an additional website/web based user interface solely dedicated to the display of stock images 420.

In step 60 of FIG. 2 the user interface 440 shown in FIG. 6-1 is displayed on the user's computer to allow the user to add text that is to be displayed alongside one or more selected images. Such text can be entered in text input fields 450 associated with the respective images. Text input by the user is transmitted from the user's computer to the server for subsequent inclusion in the movie.

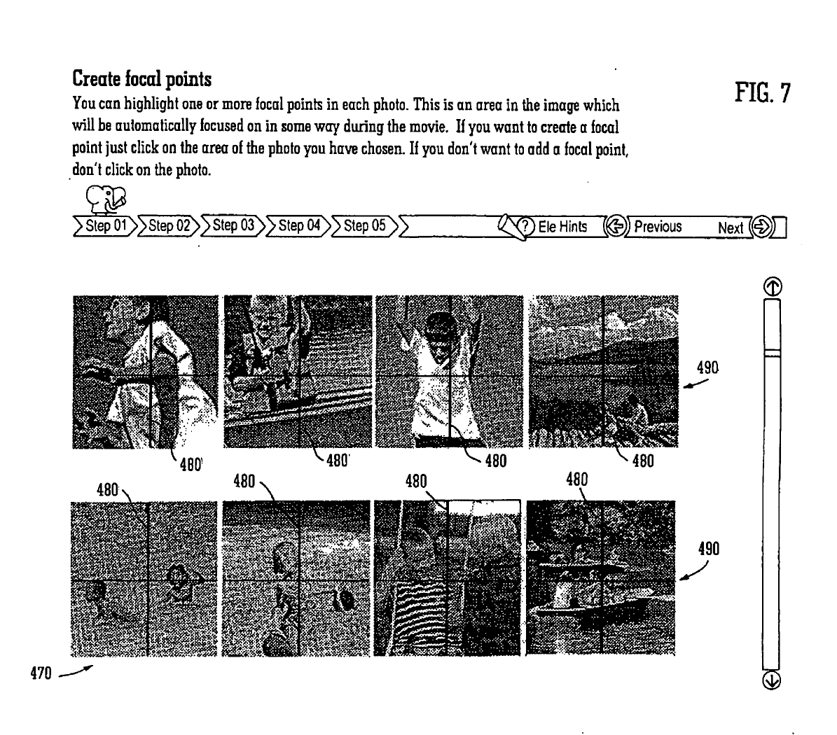

The user is then requested in step 70 of FIG. 1 to define a region or regions of the chosen images that are of particular interest to him or her. These regions will be referred to as focal points. Some of the image effects the movie manager 2 is capable of applying to the image data require the definition of a focal point on which the image effect is centred. To indicate the position of the focal points to the movie creator 1 the user interface shown in FIG. 7 is displayed. As is shown in this figure, vertical lines 480 and horizontal lines 490 are superimposed on each of the chosen images. The vertical line 480 and the horizontal line 490 initially intersect in the centre of the image. The user can drag and drop these lines until they intersect on the desired focal point. In the preferred embodiment up to five focal points can be defined for each image. Information regarding the location of the focal points is transmitted from the user's computer to the server. It is not essential that the user defines focal points. Should the user choose not to define a focal point for one or more of the images, then in one embodiment the movie manager 1 simply assumes that the region of the image that is of most interest is the centre of the image, should such an indication be required by an image effect that will later be applied. In an alternative embodiment the movie manager 1 selects an approximately laterally centred default focal point in the upper half of the still image, as the faces of pictured people are most likely to be found there.

The inventors realise that not all users have the same level of skill in terms of movie creation. For this reason the movie creator 1 comprises a function that suggests parameters of the movie that need to be defined prior to the creation of the movie from the still images. The suggestions made by this function are based on the previous selections made by the user, in particular on the general occasion/theme/mood the user has selected for the film. To allow the movie creator 1 to make adequate suggestions, the movie creator 1 comprises a database comprising information regarding all of the movie parameters that the movie creator 1 may be required to provide a suggested value for. Associated with the database entry for each value of a parameter is an indication of the moods/themes/occasions for which the value of the parameters is suited.

One parameter that the movie creator 1 may have to suggest a value for may, for example be the font choices for the movie. Various available font choices are listed in the database and an indication is given alongside each font choice regarding which mood/occasion/theme/genre the particular font choice is suitable for. It may, for example, be imagined that a cartoon styled font may be associated with an indication that it is a suitable font for a movie functioning as a party invitation but unsuitable for more sombre movies, such as movies intended as mementos for recently deceased people.

The suggestions provided to the users allow users of low skill in terms of movie creation to create movies they would otherwise be unable to create. The inventors, however, realise that more practised users may wish to select their own movie parameters or deviate from suggestions made by the movie creator 1. For this reason the preferred method requests in step 80 that the user indicates to which degree he or she should be allowed to change the parameters suggested by the movie creator 1. The user is given a choice between a basic level of permitted change, an intermediate level and a maximum level of permitted change. The movie creator 1 suggests movie parameters irrespective of which level the user chooses. The degree of change the user can apply to the suggested parameters, however, is governed by the user's indication of the desired degree of permissible change by the user.

While the user is required to provide an initial indication of the desired level of permitted change in step 80 of FIG. 2, the users can alter the chosen level of permitted change throughout the movie creation process, for example to enable the user to manually set desired parameters of the movie following a preview of an initially created movie.

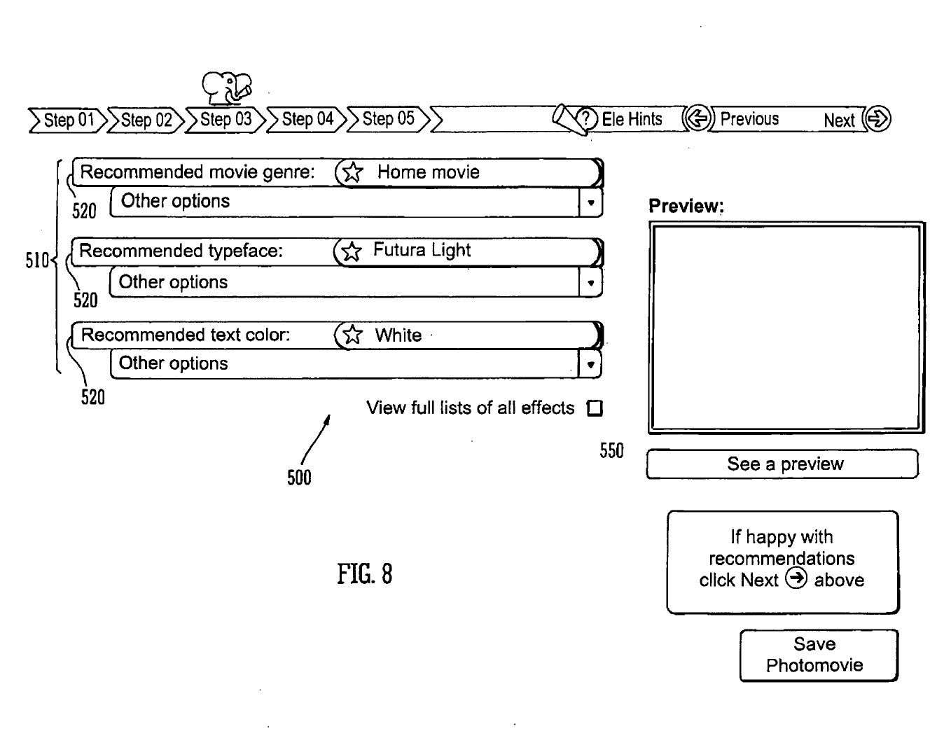

The user is presented in step 90 shown in FIG. 2 with a range of recommendations 510 for parameters and movie genres that may be used in the movie through the user interface 500 shown in FIG. 8. These recommendations 510 are based on the user's previous inputs and in particular on the theme or mood of the occasion for which the movie is created, as discussed above and include, amongst other things, image effects and transition effects the movie creator 1 considers suitable for inclusion in the movie. This range of recommendations includes recommendations 520 in movie genres, fonts and text colours. The list of available movie genres corresponds to common movie genres used by filmmakers (such as documentary movie, action movie, horror movie, etc). Each movie genre is associated with appropriate image effects, transition effects, text effects, fonts, text colours, etc that are deemed appropriate for that particular genre. When making the selection the available movie genres, fonts and colours etc are limited to those that are deemed appropriate for use in a movie having the mood or theme selected by the user.

The user can change the recommended parameters 510 using drop down menus 520. At this stage of the movie creation process the user is also given the opportunity to select the movie genre effect that will be used in the movie. The movie creator 1 also provides a preview frame 550 to enable the user to see the effect a change in a parameter has on an example movie or movie frame. A preview of two frames of the scene is provided by the method when the user activates the preview function. When the preview function is activated the movie creator 1 invokes the movie manager 2 to create two frames of the scene based on the parameters selected by the user and/or randomly determined by the movie creator 1. The two thus created frames are then returned to the movie creator 1 for display in the preview frame 550.

The changes the user can make are limited by the degree of user interaction the user has allowed himself of herself in step 80 of FIG. 2. If the user has chosen a minimum amount of permitted changes, then the user is only free to choose from a list of recommended movie genres, fonts, or colours that the movie creator 1 deems suitable for the selected mood or theme of the movie. For an intermediate or advanced level of user permitted user changes the user is free to choose from all possible parameters, movie genres, fonts and colours. For both the minimum and intermediate amount of user interaction the selected parameters and effects will be used in the entire film.

The selected movie genre will be used to generate a pool of effects deemed appropriate, which will be randomly applied to the various scenes of the movie. If the user has selected a maximum amount of permissible user changes the user is provided with the same degree of choice of parameters and effects as a user that has chosen an intermediate degree of permitted user changes. However, the user can apply the changes to separate scenes of the movie if the user has allowed himself or herself a maximum degree of permitted parameter change, rather than having to apply changes to the entire movie. The parameters selected by the user will be transmitted to the server from the user's computer. Should the user wish to change the amount of permitted parameter change, then this can be done at this stage.

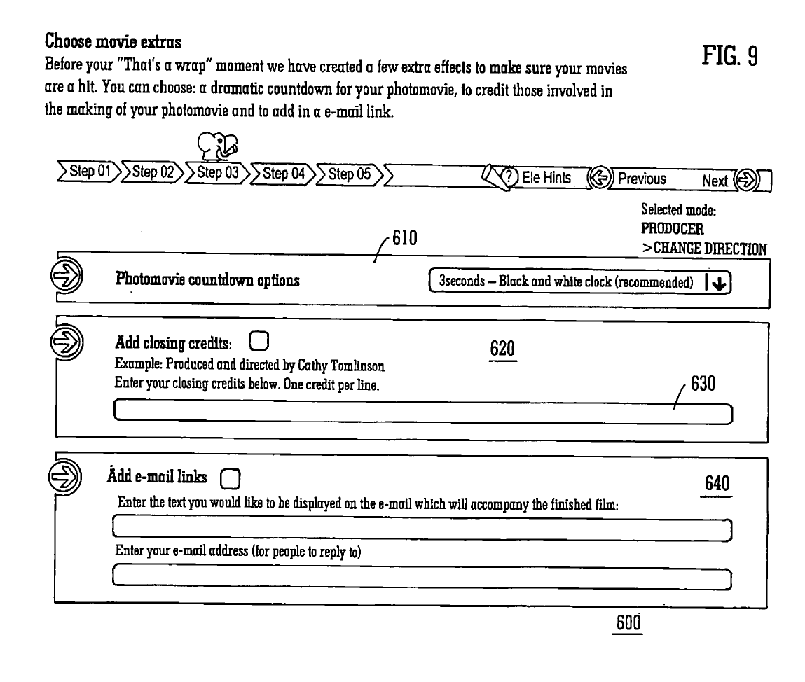

Following the above data acquisition and parameter and effect determination steps the user is given the opportunity to choose and define an opening scene and closing credits in step 100 in FIG. 2. For this purpose user interface 600 shown in FIG. 9 is displayed. There the user can choose to include an opening countdown by making the appropriate selection in field 610. Field 620 is further provided to give a user the opportunity to include closing credits. Text to be included in such closing credits can be entered in field 630. The user is further given the opportunity to add his or her email address to the closing credits of the film. Field 640 is provided for this purpose.

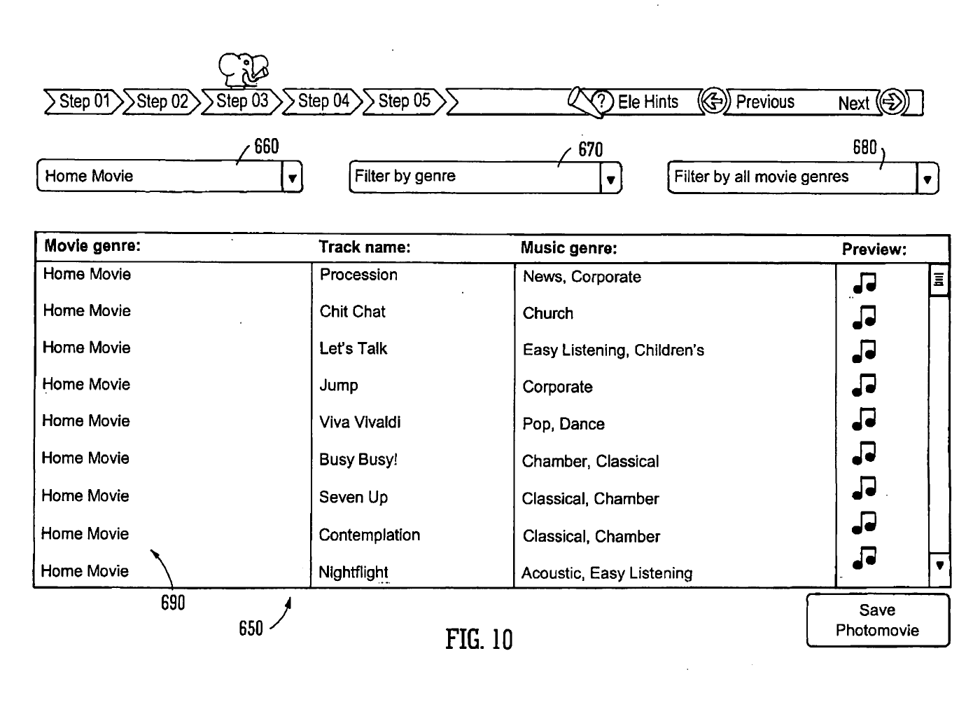

After collection of the data required for the display of the images and text provided by the user has been completed, the user interface 650 shown in FIG. 10 is displayed on the user's computer screen in step 110 shown in FIG. 2. The user can choose appropriate background music from a library of stock tracks for inclusion in the movie using the user interface 650. For this purpose the user interface 650 comprises three different ways of filtering the available tracks so that a user can select the desired track from a more limited number of suitable tracks. Three filter option icons 660, 670 and 680 are displayed for this purpose. Choosing the filter option icon 660 causes tracks which match the list of appropriate movie genres based on the mood or theme to be listed in table 690. Choosing the filter option icon 670 enables the user to select amongst any movie genre to display the list of songs which match the selected genre. Choosing the filter option icon 680 causes tracks from a specific music genre, such as “Classical”, “Rock” etc to be listed in table 690. The list of available music genres do not correspond to the moods the user was previously asked to select from for the entire movie. Instead the genres relate to the feel the track is likely to imbue on the movie. The individual tracks can also be sampled by pressing the appropriate icon in the ‘preview’ column of the user interface 650.

### The Movie Creator

### Selection of Effects

As mentioned above, the movie manager 2 relies on effects stored in the movie effect layer library 3 when generating the movie frames. A list of all effects available to the movie manager 2 is also stored in the movie creator 1. The movie creator 1 is responsible for suggesting the effects to be included in the movie, for determining the order in which selected effects will be applied and for setting the approximate duration and operating parameters of the effects.

During the data collection process shown in FIG. 2 the movie creator has suggested a selection of movie genres to the user. As explained above, this suggested list does not necessarily comprise all of the genres that are implemented by the movie manager 2/movie effect layer library 3. Instead, the list may not comprise movie genres that are deemed unsuitable for use in a movie having the theme or mood identified by the user during data collection. For this purpose, each entry in the list of all available movie genres stored in the movie creator 1 is associated with mood(s) or theme(s) for which the effect is suitable. If the list does not indicate that a movie genre is suitable for the mood or theme selected by the user, then the effects associated with such unavailable movie genres are not made available for random selection by the movie creator 1 for use in the movie.

The user may have indicated that he or she only wishes to include a certain sub-group of this list in the movie. From this suggested list or the list as limited by the user, the movie creator 1 randomly selects which image effect is to be included in a particular movie scene. The effects are applied to the still images so that the images are displayed/revealed to a viewer in the order specified by the user during data input. If an effect selected requires a focal point in the image for its correct execution, then the movie creator 1 associates a user define focal point with the effect. If a user has defined more than one focal point in an image, then the focal points are associated with the effects in the order in which the user has identified them during data input.

The selection function of the movie creator 1 is now illustrated in an example. Assume, for example, that a user has uploaded two images for consecutive use in a movie. In a first image the user has identified two focal points but no focal point has been identified by the user in the second image.

In a first selection step the movie creator 1 selects which of the image effects implicitly selected by the user by their selection of a movie genre is to be applied to the first image. If this effect requires that a focal point is specified, then the first focal point defined by the user is associated with the effect. Such an effect may, for example, be the slow zooming into the image area, a stepwise zooming, a spin zooming, a panning from an edge of the image to the area of the image surrounding the first focal point, etc.

Further image effects are applied from the predetermined list of image effects implicitly selected by the user by their choice of movie genre. If such further image effects require that focal points are specified for their correct performance, then the movie creator associates one of the focal points in the first image with the effect. This may be the first focal point but can also be the second focal point as the first focal point has already been used in an image effect. Further image effects can of course also comprise transitions between first focal points. The movie creator 1 also selects transitions between images.

The movie effect layer library 3 is capable of performing a number of different transitions. A list of all possible transitions is stored in the movie creator 1 and the movie creator 1 selects a number of transitions between two images from this list that are deemed suitable for inclusion in the movie. The user may have limited this list during data collection and the movie creator 1 randomly attributes a transition effect to each transition in the movie.

An example of a series of image effects that may be selected by the movie creator 1 for a series of three images can be:
i) Zoom in on an image area surrounding the first focal point in the first image,
ii) Continue displaying the image surrounding the first focal point but apply a shaking effect to simulate filming using a hand held camera,
iii) Zoom out again,
iv) Pan to the second focal point in the first image,
v) Provide a fade transition to the second image,
vi) Zoom in in a step wise fashion,
vii) Continue displaying the image area zoomed in on in step vi) and apply a camera shake effect,
viii) Provide a spin transition back to a focal point in the first image,
ix) Zoom out and display all of the first image to end the movie.

While the movie creator 1 is bound to order the initial display of the images in the order specified by the user, the movie creator 1 is free to repeat the display of an image an arbitrary number of times once that image has been revealed to the user.

Following the determination of the series of image and transition effects that are to be applied, the movie creator 1 determines the approximate duration each effect should take and determines approximate values for the operating parameters of the effects to be applied. The length of each effect is to some extent determined by the number of images provided by the user and the desired movie length indicated by the user. It is of course also envisaged that more than one image effect is applied for one or more of the images provided by the user. However, the ratio of movie length and the number of effects that is to be applied in the movie number only provides a guideline for the length of the effects and the movie manager unit 2 together with the movie layer library 3 are free to select the exact duration of an effect as well as the exact values of operating parameters for the effect as described below. This selection is again a random selection of a value around the guideline provided by the movie creator.

The random association of image effects to particular scenes of the movie makes it extremely unlikely that any two movies are the same, even if the input data provided to the movie creator 1 during the data collection stage is the same for such two movies. This renders each movie essentially unique.

The movie creator 1 is also responsible for selecting the text effects that are to be applied to the text provided by the user. The movie effect layer library 3 can provide a range of possible text effects and the movie creator 1 comprises a list of all text effects the movie effect layer library 3 is capable of performing. An indication of the mood(s) or theme(s) for which each effect mentioned in this list is suitable is also provided in the list. The text effects may be effects that are applied to a single letter of the text and other effects may be chosen for application to other letters of the text. Other possible text effects are applied to a number of letters of the user defined text or to all of the user defined text. The duration of each text effect may also be randomly chosen. However, text effects normally have a duration that is tailored to the length of a scene.

Similar to the way the movie creator 1 chooses image and transition effects from selected genres, text effects are selected by the movie creator 1 based on their deemed suitability for inclusion in a movie having the movie genre indicated by the user. From the suggested list or the user limited list the movie creator 1 then attributes a particular text effect to each text entered by the user. This step of attributing effects to text is again randomly performed, as is also the case for image effects and effects governing the transition between images, as discussed above.

### The Movie Manager

Once the movie creator 1 has concluded the data collection and effect selection stage of the method, the accumulated data, including the data provided by the user, the recommendations of movie parameters selected by the movie creator or by the user and instructions for the movie manager 2 to perform the selected image and text effects, are passed to the movie manager 2 for the generation of a movie based on the data.

The movie manager 2 commences computation of the frames of the movie by creating four separate layers, an image layer 1000, a transition layer 1010, a text layer 1020 and a sound layer 1030 as is shown in FIG. 11. These layers, once completed, are superimposed over each other to form the finished movie. FIG. 11 depicts these layers as a series of frames extending from frame N to frame N+B.

The image layer 1000 comprises image information relating to image effects that are performed within still images. The transition layer 1010 comprises image information relating to image effects that are performed within still images, that is image effects involving a transition(s) between two images. The frames of the text layer 1020 comprise image information relating to text effects. The sound layer 1030 comprises audio data, rather than image data, and comprises the audio information that will be presented alongside the image information in the finished movie.

It will be appreciated that each of the layers may comprise image information that is to be displayed in the finished movie and other image areas that are not to be displayed in the finished movie. The parts of the layers that are not to be displayed in the movie are rendered transparent, so that other layers can be seen through these transparent parts. One example of areas of a layer that may be rendered transparent are the areas of the text layer that do not contain text.

Moreover frames of the transition layer 1010 are rendered transparent when image effects are displayed in the image layer 1000 and vice versa. For example frames N to N+A in FIG. 11 form scene 1040 in which a rotating zoom back effect is performed. All of the image information to be displayed in this scene is contained in the image layer 1000 while the corresponding frames of the transition layer 1010 are transparent, as indicated in FIG. 11 by presenting these frames hatched.

Frames N+A to N+A+3 form scene 1050 in which a fading transition from the last image of scene 1040 to the first image of a further scene 1060 is performed. The entire image information displayed in this scene 1050 is contained in the transition layer 1010, while the corresponding frames in the image layer are transparent.

The movie manager 2 computes the data received from the movie creator 1 in four passes as is illustrated in FIG. 12. In a first pass 1210 the movie manager determines which of the movie's frames are to form the first and last frames of each scene. As mentioned above, the movie creator 1 has provided a guideline for the length of each scene and this guideline forms the basis for this first pass performed by the movie manager 2. The movie manager is, however, free to deviate from the prescribed length of the movie, for example if this is necessary for the optimised performance of the effect and as long as the overall length of the movie is not altered.

In a second pass 1220 the movie manager 2 associates each scene with the data that is to be displayed in that scene. For example for scene 1040 the movie manager 2 associates the image to be rotated in the image layer 1000 with the image layer, a caption text to be displayed in the text layer 1020 with the text and a section of audio data of appropriate length with the sound layer 1030.

In a third pass 1240 the movie manager 2 applies the effect prescribed by the movie creator 1 to the data. As mentioned above, the movie manager 2 invokes methods provided by the movie effect layer library 3 for this purpose. These methods perform the required computation on the provided input data. Computation for frame N+1 is for example performed based on the entire image displayed in frame N.

Each method comprises a number of operating parameters that governs the method's performance. For example, a method ‘zoom’ also requires an input of the zoom factor that is to be applied. The operating parameters that are to be used for computation are determined by the movie manager 2 in combination with the movie effect layer library 3 by randomly selecting a value for the operating parameter from a range of permissible values and following the guidelines provided by the movie creator 1. The range of permissible values may again be limited by the mood, theme or genre selected by the user. It may, for example, be fully acceptable to apply a zoom effect that reduces the image area shown to a quarter over 10 frames for a movie relating to a party. The application of the same zoom effect may, however, be deemed unsuitable for a movie that is intended as a memento for a deceased person. The movie manager 2 may in this situation limit the zoom factor to better suit the theme of the movie. Further examples are the limiting of panning and rotation speeds, the limiting of camera shake etc. A camera shake effect may, for example, have been randomly selected by the movie creator 1. The range of all possible operating parameters for such a camera shake effect can cover the slight shaking produced by a hand held camera as well as shakings that may be experienced during an earthquake. Based on the mood of the movie the camera shake effect will then have been limited to only a “slight” shaking, such as may, for example, have been produced by producing the film using a hand held camera. The movie creator 1 thus, for example, can specify that the shake effect is not to exceed ten pixels in a vertical direction, twenty pixels in a horizontal direction within every twenty frames of the movie. The movie manager unit 2 then determines using a further random selection step the exact number of pixels in the vertical and horizontal direction that the image is to move within each set of twenty frames. The selection and configuration of the ‘shake effect’ is thus based on three random selections. Firstly, the shake effect has been selected on a random basis from a list of available or desired effects. Secondly, the maximum intensity of the shake effects has been determined by the movie creator 1 based on the mood, theme or genre of the movie and thirdly the movie manager unit 2 has then determined the actual parameters for performing the effect. It will be appreciated that this threefold application of random selection in the movie creation process is not limited to the camera shake effect. Instead, this threefold random selection can be applied to all desired image effects.

It will of course be appreciated that many image effects are defined by a number of parameters, rather then by a single parameter. It is conceivable that less than all of these parameters are limited to adapt the appearance the image effect has in the movie to the theme, mood or genre of the film. The zoom effect, for example may be described by a number of parameters, such as start and end zoom percentages, the number of frames over which the effect should take place, the location of focal points and a degree of rotation applied during the zoom effect as well as a parameter describing variations in the amount of change in the zoom factor per frame, generally referred to as ‘easing type’. It may, for example, be imagined that the start and end zoom factors as well as the number of frames for the scene are fixed and cannot be changed. It may still, however, be possible to adapt the effect to the mood, theme or genre of the movie by suitably setting the easing type. It may, for example, be specified that at the beginning of the zoom effect the amount of zoom applied between adjacent frames is small and that this amount should accelerate with increasing frame number, first slowly, then more rapidly. A zoom effect adapted in this manner can be imagined to be considerably more suitable for a movie having a more mellow mood than for a movie having a celebratory mood.

The method provided by the movie effect layer library 3 invokes the appropriate flash action script and provides output in the form of a series of new frames relating to the invoked effect/script. An example is shown in frames N+1 to N+A−1 of FIG. 11, which illustrate frames that have been created by a method ‘RotateAndZoom’ from the image data presented in frame N and based on instructions to zoom out by a specified percentage and to rotate the image data in the counterclockwise direction by a number of degrees.

The movie manager 2 also applies the text effects prescribed by the movie creator 1 to the text data supplied by the user via the movie creator 1. Each letter of the text is treated by the movie creator 1 as an independent entity and the movie creator can specify that a different text effect is applied to each letter. It is of course also possible to apply the same text effect to all letters or to treat a number of letters as a group to which a single text effect is applied. Again, the movie manager 2 supplies the letter or letters of text to be included in the effect to a method provided by the movie effect layer library 3 and invoked by the movie manager 2. As discussed above, the type of effect that is to be used is selected by the movie creator 1. The movie manager 2, however, selects the parameters governing the performance of the function. Thus for example, the movie creator 1 may specify that a particular letter combination is to be moved into the display from an edge of the display to a specified point in the display in one scene. The movie manager 2 may, however, determine within how many frames this movement is performed.

The movie manager 2 selects the parameters that are to be used by the method provided by the movie effect layer library 3 randomly from a predetermined range of parameters. This predetermined range of parameters may be narrower than a possible range of parameters that could be used for a particular effect. The movie manager 2 makes parts of the possible range of parameters unavailable for selection if any such part is considered not suitable for use in a movie having the user specified theme, mood or genre.

The movie manager 2 comprises a database that includes information regarding which sub-ranges of the possible parameter ranges are suitable for use in a movie having a given theme, mood or genre. Based on this information the movie manger 2 restricts the range of the parameters that are available for selection to those parameters indicated as being suitable for a movie having the mood, theme or genre indicated by the user.

In the third pass the movie manager 2 also applies transition effect in the transition layer 1010 in a manner equivalent to the application of image effects to the image layer 1000.

It should be noted that each of the layers 1000 to 1030 is “aware” of the content the other layers and that information regarding layer contents is taken into account when the image data in the layers is created and/or manipulated. The text layer, for example, is arranged not to place text on a focal point used by the image layer for a long period of time. This “awareness” impacts on the random selection performed by the movie manager unit 2. A random selection of a position in which to rest text, for example, will be designed to avoid resting the text on the focal point(s) of the still image.

Each of the layers 1000 to 1030 is stored in a separate SWF file to facilitate later layer manipulation by the user. The layers are then combined/overlaid and stored as completed movie in a separate SWF file. With the storing of these files the movie manager's involvement in the movie creation process is completed, at least until an attempt to edit the movie is made by the user.

### Movie Creator

### Changes to the Sample Movie

The movie created by the movie manager 2 can be reviewed by the user using the movie creator 1 as interface. Should the user wish to make changes to the movie, then this can be done after previewing the movie. The user may, for example, decide that a chosen focal point had been incorrectly set and may wish to move this focal point slightly. Additional focal points may be set at this stage or focal points deleted. Other changes may relate to the type faces of the animated text etc. The degree of freedom to change parameters the user is given at this stage depends again on the level of interaction the user had previously indicated he or she wishes to have. If the user has chosen a minimal degree of freedom, then the user will be limited to altering the movie parameters from within a predetermined list of parameters that is based on the theme, mood or genre of the movie. If the user has indicated that he or she wants to have an intermediate level of choice, then the user is free to choose from all possible parameters and effects. For both these levels of interaction, however, all of the chosen parameters and effects are applied to the entire movie. If the user has chosen to have maximum input in the movie creation process, the movie creator 1 allows the user to edit the movie scene by scene, that is to define parameters and effects for each scene if so desired. The level of interaction the user has in the movie creation process can be adjusted at this stage of the movie creation process, as at any other stage of the process.

FIG. 13 shows a user interface 1300 displayed to a user that has elected to have maximum input in the movie creation process for review and editing of the movie. A time bar 1310 symbolising the duration of the entire movie is subdivided into a number of fractions 1320, each fraction symbolising a scene of the movie. Each scene can be displayed in a display area 1330. By highlighting one of the fractions 1320 the associated scene is displayed in the display area 1330. An array 1340 of drop down menus 1350 is also provided. Activation of a drop down menu presents the user with the full range of effects available for inclusion in the scene in question. The user may, for example, choose to use image and transition effects other than those randomly selected by the movie creator 1, to change the colour of text used in the scene, to change text effects, to add or delete a caption, to crop a picture or even to base a scene on an entirely different still image. It is also possible to add further effects to the movie to increase the depth of the movie. A user may thus choose to overlay predetermined environmental effects, such as snow fall, fog or falling leaves over a movie scene, to provide an overlay of an embellishing effect, such as floating hearts or camera flash effects at this stage of the movie creation process.

FIG. 14 shows a user interface 1400 displayed to a user that has elected to have an intermediate amount of input in the movie creation process for review of the movie. As can be seen from FIG. 14, a user that has chosen to have an intermediate level of input in the movie creation process is presented with a summary of all the parameters on which the movie is based. Each of these parameters applies to the entire movie, rather than to separate scenes and can be edited. The degree of permitted user interaction can be changed at this stage.

Once the user has finished adjusting the parameters of the movie the movie can be previewed. In the preview stage of the movie creation process the movie creator merely permits a change of the movie parameters and omits any random selection of image effects. The image effects used in the edited movie will thus remain the same as in the originally generated movie (unless the user has changed any such effect using scene editing as described above). The amended movie parameters and image data (if applicable) are then passed to the movie manager 2 a further time. The movie manager 2 re-computes the sections of the image layer 1000, the transition layer 1010, the text layer 1020 and the sound layer 1030 that are affected by the changes. The image manager 2 then combines the layers into an amended movie which can again be reviewed by the user through the movie creator 1. The general look of an amended movie will thus be very similar to that of the originally created movie, albeit including the changes made by the user.

If the user is satisfied with the created movie the movie can be purchased. Following the purchase of the movie the movie is electronically delivered to a destination specified by the user, for example to the user's or another party's computer, to the user's or another party's mobile telephone or to a social networking site specified by the user.

It will be appreciated that the above description relates to a specific embodiment of the present invention and that modifications to this embodiment are possible without departing from the spirit and scope of the present invention as defined by the claims.

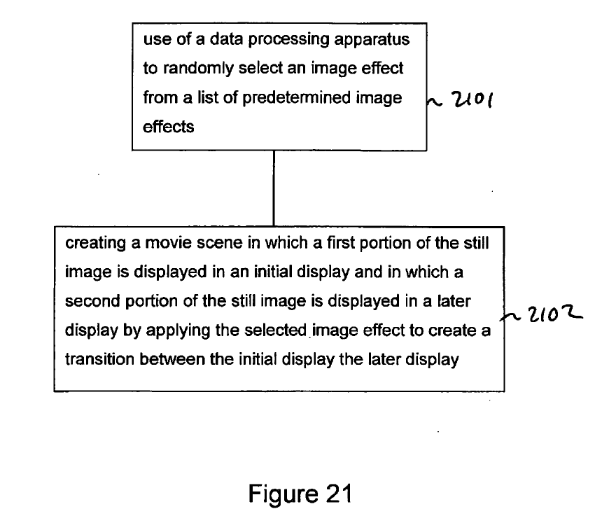

A preferred embodiment of the present invention relating to the creation of a movie scene in which an image effect operating on a single still image is applied can for example be expressed more generally in the form shown in FIG. 21. As shown in this figure, in a first step 2101 a data processing apparatus is used to randomly select an image effect from a list of predetermined image effects. In a second step 2102 a movie scene in which a first portion of the still image is displayed in an initial display and in which a second portion of the still image is displayed in a later display is created by applying the selected image effect to create a transition between the initial display the later display.

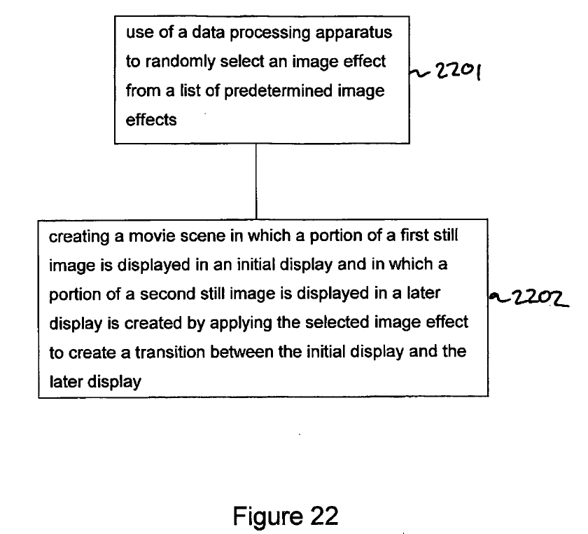

A preferred embodiment of the present invention relating to the creation of a movie scene in which an image transition effect creating a transition between two still images can for example be expressed more generally in the form shown in FIG. 22. As shown in this figure, in a first step 2201a data processing apparatus is used to randomly select an image effect from a list of predetermined image effects. In a second step 2202 a movie scene in which a portion of a first still image is displayed in an initial display and in which a portion of a second still image is displayed in a later display is created by applying the selected image effect to create a transition between the initial display and the later display.

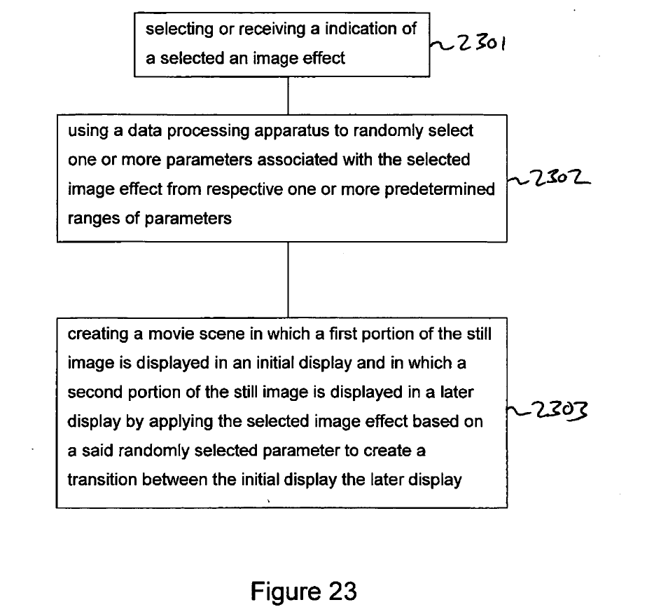

A preferred embodiment of the present invention relating to the creation of a movie scene in which an image effect operating on a single still image is applied can in a further example be expressed in the form shown in FIG. 23. In a first step 2301 an image effect is selected or an indication of a selected image effect is received. In a second step 2302 a data processing apparatus is used to randomly select one or more parameters associated with the selected image effect from respective one or more predetermined ranges of parameters. In a third step 2304 a movie scene in which a first portion of the still image is displayed in an initial display and in which a second portion of the still image is displayed in a later display is created by applying the selected image effect based on a said randomly selected parameter to create a transition between the initial display the later display.

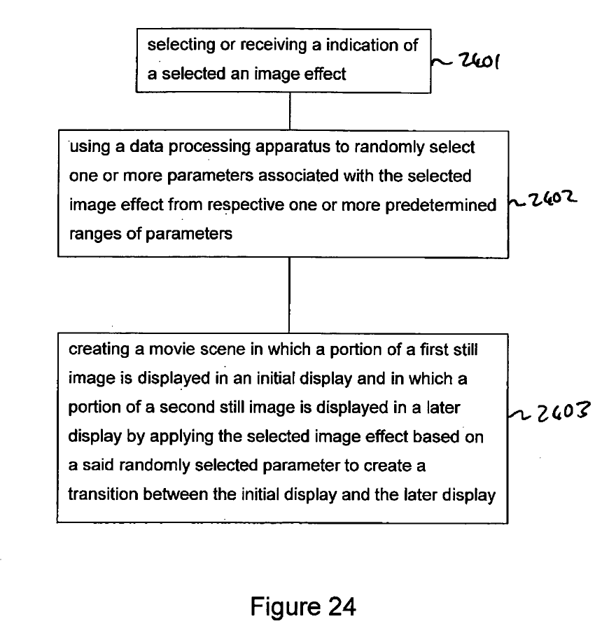

A preferred embodiment of the present invention relating to the creation of a movie scene in which an image transition effect creating a transition between two still images can in a further example be expressed in the form shown in FIG. 24. In a first step 2401 an image effect is selected or an indication of a selected image effect is received. In a second step 2402 a data processing apparatus is used to randomly select one or more parameters associated with the selected image effect from respective one or more predetermined ranges of parameters. In a third step 2403 a movie scene in which a portion of a first still image is displayed in an initial display and in which a portion of a second still image is displayed in a later display is created by applying the selected image effect based on a said randomly selected parameter to create a transition between the initial display and the later display

It will moreover be understood that it is not obligatory for the movie creator 1 to perform the data collection steps 20 to 80, 100 and 110, in the order described with regard to FIG. 2. In an alternative preferred embodiment, the step of selecting an occasion 20 shown in FIG. 2 is, for example, performed after the step of selecting a movie length 30 also shown in FIG. 2. It will be appreciated that the selection of the appropriate movie length is technical in nature as it requires an estimate of the length of time a given number of photographs is likely to usefully fill in the context of a movie. The selection of an appropriate occasion in contrast requires consideration of the overall look and feel that the movie is intended to achieve. This selection is therefore less technical than the selection of an appropriate movie length and instead concentrates on the artistic elements of creating the movie. Re-ordering the steps of selecting the movie length and the selection of the occasion for the movie therefore allows completing steps requiring technical consideration before starting steps requiring more creative considerations.

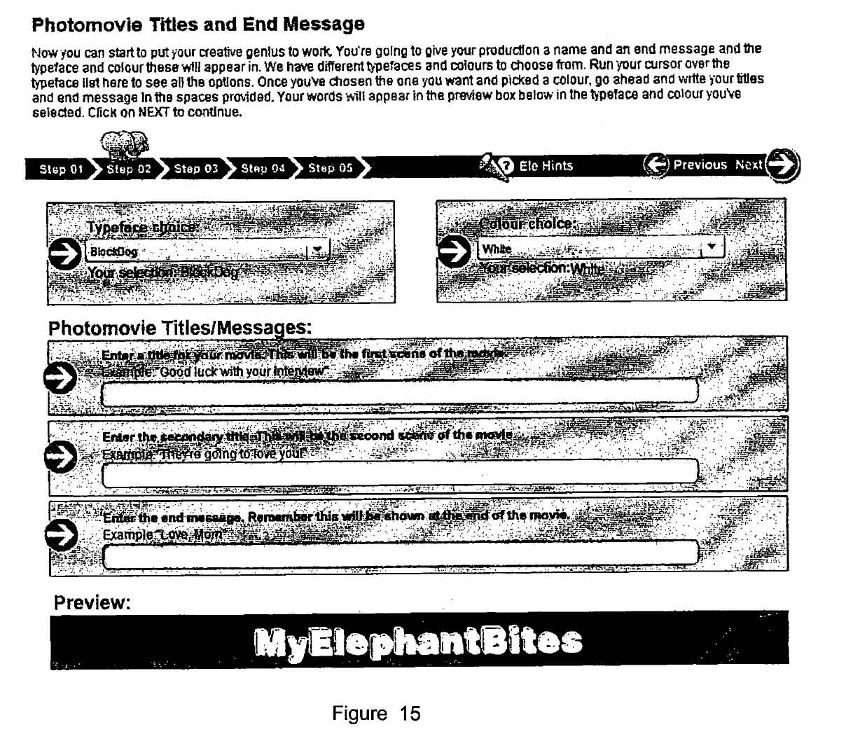

It will also be appreciated that the data required for creating the movie can be obtained in any suitable order and is not limited to the order described above with regard to FIGS. 2 to 10. It is also envisaged that some or all the data input fields shown in FIGS. 3 to 10 and 13 are presented at a different point in time during the data collection exercise and/or in a different data input screen. The selection of typeface and text colour requested in the above described embodiment in the context of FIG. 8, can in another preferred embodiment for example be paired with the entry of opening and closing messages described above with regard to FIG. 5. An alternative user interface that combines the selection of typeface and text colour with the selection of opening and closing messages according to a preferred embodiment is shown in FIG. 15.

It will be appreciated that the user interface shown in FIG. 15 does not give the user the option of selecting a movie genre, as is the case in the embodiment described with regard to FIG. 8. In the FIG. 8 embodiment the user is given the choice to imbue a movie for a previously selected occasion with the feel of a specific movie genre. In an alternative embodiment the user is given this choice when selecting the occasion the movie is to serve for, for example in an additional processing step following step 20 in FIG. 2.

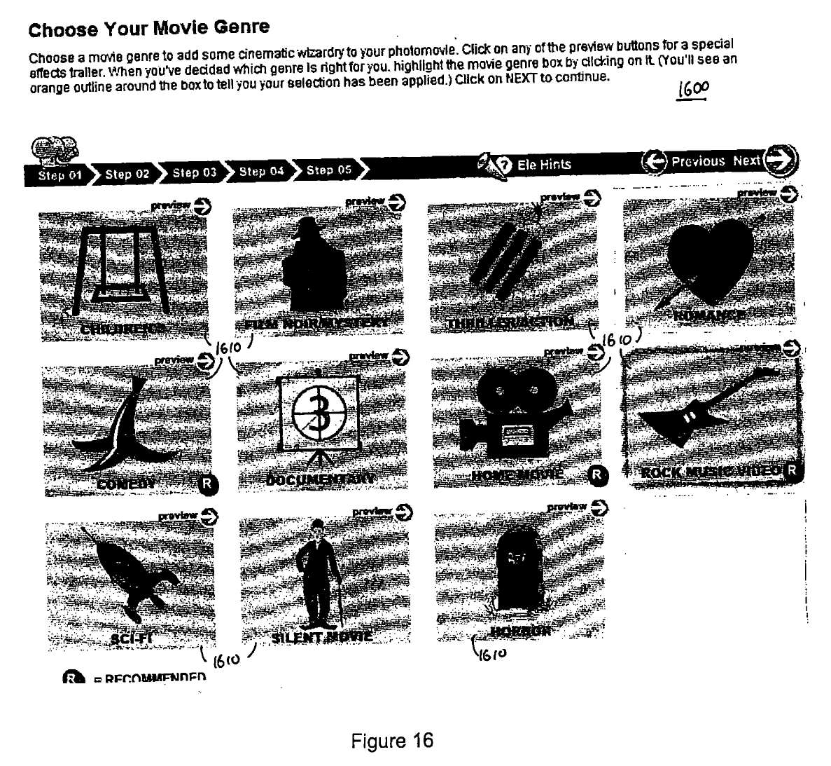

In yet another alternative embodiment the selection of a movie genre may replace the step of selecting an occasion (step 20 in FIG. 2). The user may, for example, be presented with a separate input screen dedicated to the selection of a genre for the movie. An exemplary input screen 1600 comprising icons 1610 that can be activated by a user to select a desired movie genre is shown in FIG. 16. In the preferred embodiment each of the icons 1610 is arranged to show exemplary effects associated with the corresponding genre to show the user how the selection of the particular genre will likely influence the movie creation process.

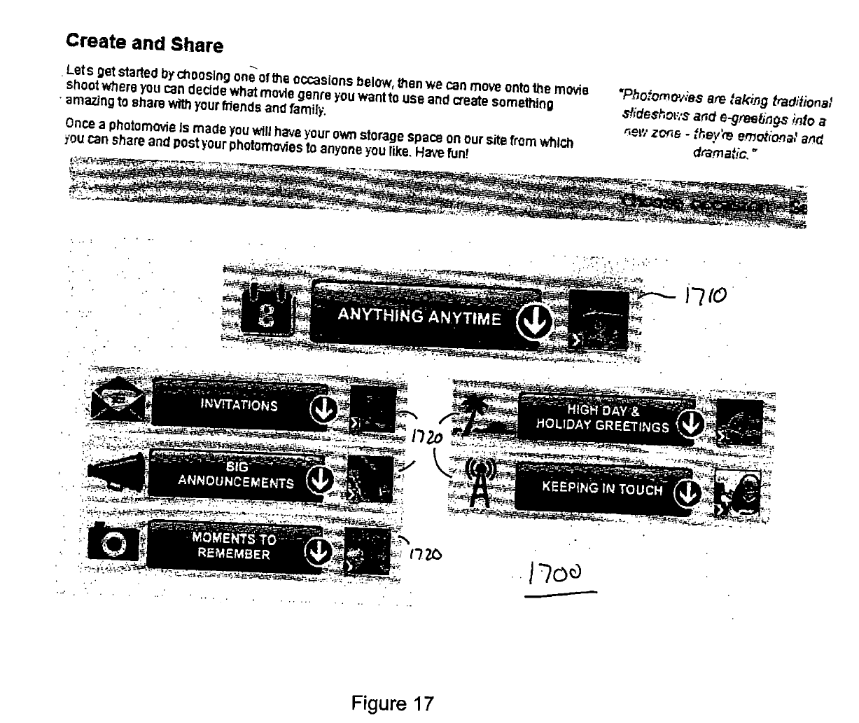

It is also envisaged to permit the user to choose a movie genre without the need to select an occasion for the movie. This can, for example, be done by replacing the user interfaces shown in FIGS. 3-1 and 3-2 with the user interface shown in FIG. 16. To aid the user in the task of selection of a movie genre the user may be ask to nevertheless indicate the occasion for the movie. The user's selection is then used as basis for suggestions of movie genres suitable for the occasion. An alternative user interface that may be used for the selection of an occasion for the movie is shown in FIG. 17. This user interface permits selecting an occasion by activating one of the icons 1720. If the user activates one of the icons 1720 a user interface similar to that shown in FIG. 16 but limited to a choice of movie genre that is deemed suitable for use in making a movie for the selected occasion is displayed. The user is, however, also given the choice to progress the selection process to the full user interface shown in FIG. 16. This user interface will be displayed if the ‘anything anytime’ icon labelled 1710 is activated.

### Selection of Image Effects and/or Image Transition Effects

The selection of image effects and/or image transition effects is described above with regard to a specific preferred embodiment. In the following this description will be expanded upon. It will be appreciated that the following disclosure may be used in conjunction with the above discussed embodiment or in isolation from it in the context of other embodiments.

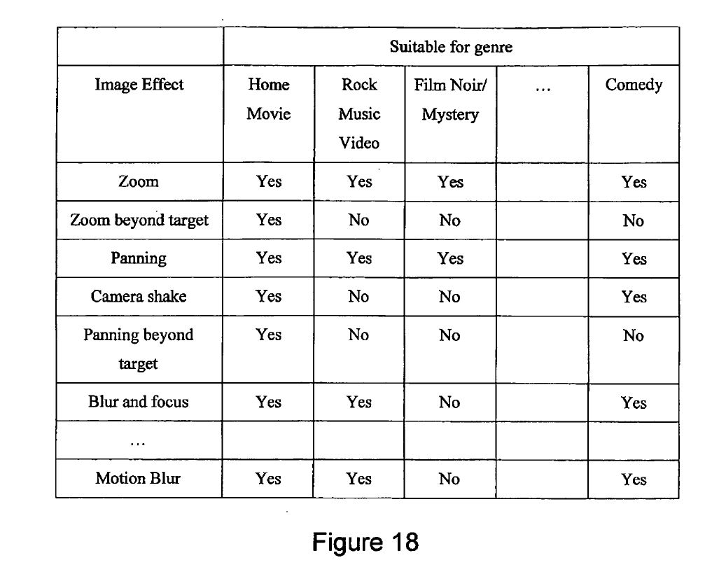

In a preferred embodiment information is stored in the data processing apparatus performing the selections step, such as the movie creator 1, wherein the data indicates whether or not a particular image effect and/or image transition effect is suitable for use in creating a movie scene for a movie in a particular movie genre. FIG. 18 shows an exemplary table storing the relevant information for a small number of image effects and genres. It will be appreciated that a table of this nature, when implemented in a data processing apparatus is likely to comprise a considerably larger number of image effects, preferably all of the image effects that can be applied to still image data, as well as a considerably larger number of movie genres, again preferably all of the genres defined in the context of the movie creating method. It will also be appreciated that a similar tables will desirably be provided detailing the suitability of using specific image transition effects, overlay effects and text effects etc. in defined movie genres.

As can be seen from FIG. 18, the suitability of each of the listed image effects for use in each of the listed movie genres is stored in the context of this table. Certain commonly used image effects, such as zooming and panning for example can be seen to be suitable for use in creating movie scenes for all movie genres. Other image effects, however, may not be suitable for use in creating movie scenes for all movie genres. The effect of panning towards a predetermined target, for example a focal point centring on the face of a person in the still image, then panning past that target only to subsequently pan back to the target (indicated as ‘panning beyond target’ in FIG. 18) for example is intended to emulate the effect of inexpert use of a hand held camera when making a home movie, where the intended target for the next scene of the home movie is initially simply missed/panned over. This effect is of course not suitable for use in a movie that is intended to have a professional feel to it. The table shown in FIG. 18 indicates the movie genres for which the image effect is not to be used.

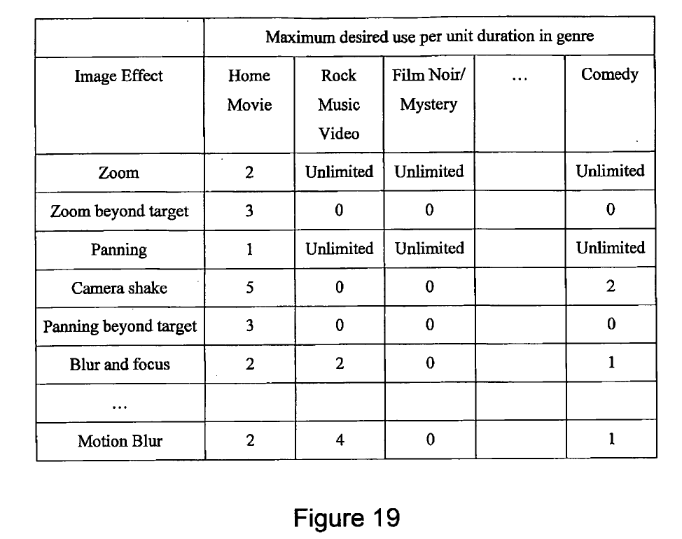

When selecting image effects and/or image transition effects for use in a movie scene the data processing apparatus in one preferred embodiment limits the pool of available image effects and/or image transition effects from which an effect to be applied will be chosen to those effects indicated as being suitable for the movie genre chosen by the user. FIG. 19 shown an alternative table providing information as to how often an image effect should maximally be used during a predetermined unit length of the movie, for example within a time frame of 5 seconds. It will be appreciated that a similar table will also be provided for image transition effects in a preferred embodiment. A comparison of FIGS. 18 and 19 shows that the table of FIG. 19 comprises all of the information provided in the table of FIG. 18 in the sense that incompatibility between an image effect indicated by the entry ‘No’ in FIG. 18 is conveyed by the information that the maximum desired use of the relevant image effect is ‘0’. In addition to the information provided by the table of FIG. 18, however, the table of FIG. 19 also weights the suitability of image effects for use in the various movie genres. It may thus be that some image effects, while deemed suitable for use in two movie genres (see, for example the effect ‘Camera Shake’ in FIG. 19), are deemed suitable for frequent use in one movie genre but for less frequent use in another movie genre. Thus, for example, the effect ‘Camera Shake’, may be deemed suitable for frequent use in the home movie genre to convey a somewhat inexpert feel often associated with home movies to the viewer. It may, however, be desirable not to convey the same degree of inexpert feel to movies in another movie genre, such as the ‘Comedy’ genre as indicated in FIG. 19.

The process of selecting an image effect and/or an image transition effect for creating a movie scene may use the maximum desired number of uses of an effect as detailed in FIG. 19 as a weighting factor in a weighted selection process of the image effect to be used in a particular movie scene. The weighted selection process is preferably of such nature that the weights provided in FIG. 19 automatically limit the number of uses of each effect in each unit duration of the movie to less or equal the number stated in FIG. 19. The weighted selection process is preferably a random weighted selection process.

It will be appreciated that, if the above discussed weighted selection process is used it is not necessary to limit the ‘pool’ of image effects on which the selection is based to those effects having a non-zero weight (although such limitation can of course still be performed). Instead these effects can be retained as a viable target for selection, wherein the likelihood of selection is very low owing to the zero weight associated with such effects.

In another preferred embodiment the data processing apparatus selecting effects for use in a movie keeps is arranged to only select effects that have not or no more than a predetermined number of times been used in the movie. Such a data processing apparatus may, for example, be arranged to comprise an ‘in movie memory’ in which the use of image transition effects, image effects, overlay effects, graphics effects (such as colour change effects) and text effects is tracked so that repeated use or undue repeated use cannot occur. In one arrangement, for example, the repeated use of an effect within a period spanning five effects is prevented. Moreover, in one preferred embodiment effects producing a similar outcome to that of an already used effect are recognised and also avoided as part of the ‘in movie memory’ function.

A, ‘in movie memory function of this type can in one preferred embodiment, be combined with a weighted selection step similar to that discussed with reference to FIG. 19. In this preferred embodiment the pool of available image effects (or image transition effects, overlay effects, text effects etc.) is limited by the selected genre so that effects not suitable for use in the genre are excluded from selection. Each of the effects deemed suitable for use in the chosen movie genre is then associated with a likelihood of selection. The likelihood values act as weights in the step of selecting an effect. The likelihood values are chosen such that their sum is 100%. The likelihood value associated with a particular effect therefore not only depends on how suitable the effect is deemed to be for the particular movie genre but also on the number of effects available for selection.

As an example, one can consider that, based on FIG. 19, for the movie genre ‘Home Move’ the effects ‘Zoom’, ‘Zoom Beyond Target’, ‘Panning’, ‘Camera Shake’, ‘Panning beyond Target’, ‘Blur and Focus’ and ‘Motion Blur’ are available. It will be understood that these effects are only listed for illustrative purposes and that, in a real life implementation of the described selection embodiment a considerably larger number of effects will be available. These effects may be deemed to be more or less suitable for use with the ‘Home Movie’ genre, as for example indicated by the weights listed in FIG. 19. A likelihood distribution for the selection of one of these effects according to the preferred embodiment is then shown in the column of Table I labelled ‘1^{st} selection’.

Assume now that in the first selection step the effect ‘Zoom Beyond Target’ is selected. The likelihood that this effect is selected in the second selection step is then reduced to zero and the likelihood that the remaining effects are selected increases proportionally. An appropriately adjusted likelihood distribution shown in the column of Table I labelled ‘2^{nd} selection’. The likelihood distributions listed in the columns labelled ‘3^{rd} selection’ to ‘5^{th} selection’ are determined in the same manner as that shown in the column labelled ‘2^{nd} selection’, assuming that the effects selected in the respective selection steps after the 1^{st} selection step are ‘Panning Beyond Target’, ‘Camera Shake’ and ‘Blur and Focus’.

After the 5^{th} selection step the initially selected effect, ‘Zoom Beyond Target’, in this case can be re-used and the likelihood distribution applicable to a 6^{th} selection step may be as shown in the column of Table I labelled ‘6^{th} selection’, if in the 5^{th} selection step the ‘Zoom’ effect is chosen.

TABLE I

| | Likelihood of Selection | | | | | |
|---|---|---|---|---|---|---|
| | 1^{st} | 2^{nd} | 3^{rd} | 4^{th} | 5^{th} | 6^{th} |
| Effect | selection | selection | selection | selection | selection | selection |
| Zoom | 11.1% | 13.3% | 16.7% | 28.6% | 40% | 0% |
| Zoom | 16.7% | 0% | 0% | 0% | 0% | 50.0% |
| Beyond Target | | | | | | |
| Panning | 5.5% | 6.7% | 8.3% | 14.3% | 20% | 16.7% |
| Camera | 27.8% | 33.3% | 41.7% | 0% | 0% | 0% |
| Shake | | | | | | |
| Panning | 16.7% | 20.0% | 0% | 0% | 0% | 0% |
| Beyond Target | | | | | | |
| Blur and | 11.1% | 13.3% | 16.7% | 28.6% | 0% | 0% |
| Focus | | | | | | |
| Motion Blur | 11.1% | 13.3% | 16.7% | 28.6% | 40% | 33.3% |
| Total: | 100% | 100% | 100% | 100% | 100% | 100% |

It will be appreciated that in a real life implementation of this embodiment of a weighted selection step a considerably larger number of effects is likely to be available for selection.

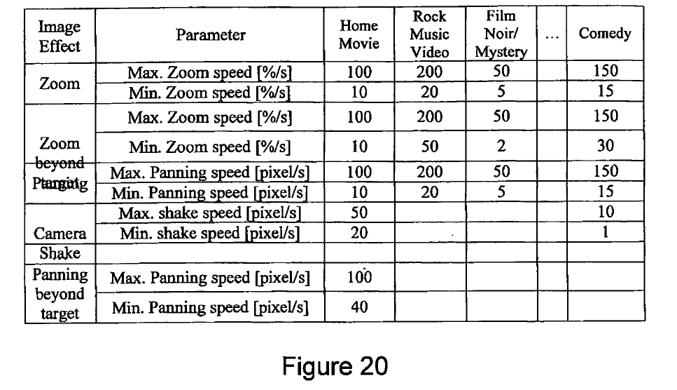

As discussed above, it may be necessary to further select a parameter determining the performance of an image effect or image transition effect before this effect can be applied in creating a movie from still images. As also discussed above, this parameter selection may be split into two selection steps, namely a first selection step in which maximum and minimum parameter values are selected and a second selection step in which the actual parameter is selected from the limited range of possible parameters created by the first selection step. FIG. 20 shows a further table detailing absolute limits operating parameters must not exceed when they are used in creating a movie scene according to a particular genre. It will be appreciated that the number of effects and genres detailed in the table of FIG. 20 is limited to improve the clarity of this table and that a table implemented in a data processing apparatus would comprise a considerably larger number of effects, preferably all available effects, and also a considerably larger number of movie genres, preferably all available move genres. A similar table for image transition effect, overlay effects, text effects, etc. is also provided in a preferred embodiment.

The first selection step above may be based on the table shown in FIG. 20 and may merely comprise a reading of the relevant maximum and minimum values for the operating parameter(s) of an image effect if it is applied to a particular user identified movie genre. The so established range of allowed operating parameters may then be used as basis for the second selection step. It will be noted that the table of FIG. 20 does not comprise values for Image effects that are deemed unsuitable for use in creating a movie scene for a specific movie genre, as such unsuitable effects may simply be ignored in the creation of a movie in the specific movie genre. It is, however, envisaged to also provide maximum and minimum operating parameters for such effects if the weighted selection method discussed above with regard to FIG. 19 is used for selecting image effects if the likelihood of selection of an undesirable image effect is non-zero.

While the above description relating to FIGS. 18 to 20 solely relates to the relationship between movie genres and image effects and image transition effects respectively, in another preferred embodiment similar tables are provided for detailing the relationship between a particular occasion chosen by a user and the image effects and image transition effects, between a particular theme chosen by a user and the image effects and image transition effects and/or between a particular mood chosen by a user and the image effects and image transition effects.

The above discussion relating to FIGS. 18 to 20 has concentrated on the selection of image effects and image transition effects as well as on the selection of operating parameters for use with such effects. A chosen operating parameter, say for example a chosen panning speed, can of course be applied continuously during the entire duration of the image effect or the transition effect. The chosen operating parameter preferably, however, forms an input value governing the time dependent properties of an easing type used when applying the selected effect. Easing types are well known in the art and describe the time dependent properties of an effect. It can, for example, be envisaged that a zoom effect, instead of being applied so that the zoom rate is constant over its performance, is applied so that initially there is a rapid acceleration in the zoom rate, followed by a similarly rapid deceleration. The average zoom rate may then be defined by the chosen parameter while the time dependent properties of the zoom function are defined by the easing type associated with the selected effect. Additionally, for effects that allow for such function, the selected operating parameter may further be used to define operating conditions other than average operating conditions. It may, for example, be imagined that a selected zoom speed in a ‘zoom beyond target’ function also defines the amount by which the effect zooms beyond the target. The operating conditions governed by the selected parameters are defined by the easing types, as is well known in the art.

The above description relating to creating a movie based on a user's selection of the desired movie genre has been made with reference to examples focusing on the selection of image effects that are deemed to give the movie an appearance that is in conformity with the appearance a user expects from a movie in the selected genre. The appearance of a movie is, however, not only determined by the image effects used. Rather, all of the effects used in creating the movie may have an influence on its overall appearance and on whether or not the movie appears to fall within the selected genre. Preferred embodiments of the present invention are therefore not limited to restricting the selection steps that define the appearance of the movie to selecting image effects so that the movie appears in a manner the user would expect based on his or her choice of genre. Instead other effects are also selected so that effects that are not deemed suitable for use in a movie having the selected genre are avoided. Effects that may be subject to such a limiting selection include the above mentioned image effects (that is effects performed within one still image), Image transition effects (that is effects governing the transition between two images), text effects and overlay effects. In the following examples of effects deemed particularly suitable for inclusion in a movie having a particular genre are provided.

The science fiction genre may, for example, be characterised by the use an image transition effect in which images are revealed dissected by a grid matrix, for example a silver grey grid matrix. Image transition effects can of course also make use of image masks in which the second image of the transition is preferentially revealed or obscured. Such image masks may take a form that is particularly suitable for use in a particular movie genre. In the science fiction movie genre for example such an image mask may take the shape of an alien/alien head, a UFO. The size of such a mask may also be altered as the effect progresses so that, for example a bursting through of an alien through the ‘old’ image can be simulated. Another image transition effect that may be used in the science fiction genre is the revealing of an image based on a simulation of a laser beam reminiscent of the ‘beaming’ of personnel in the Star Trek series. Image transition using distortion reminiscent of distortions seen in science fictions film may also be suitable for use in this genre.

The science fiction genre may also avail itself of overlay effects, such as star field simulations, depictions of UFOs travelling across or hovering on the screen display and silver grey orbs hurtling out of the screen toward the viewer. Such overlay effects may be superimposed over still image data. Alternatively or additionally such effects may be suitable to create an introduction to the movie.

Text effects may also be used in defining the genre the movie relates to. It is, for example envisaged that intensity of text displayed during the movie may increase locally so as to simulate a laser light flash travelling along the text. Alternatively text may initially be displayed in a pretended coded version, which is then simulated to rapidly de-code on screen.

Image effects in the science fiction genre also preferably focus on the use of specific colours, preferably green an black to add to the atmosphere of alien perception. An image may thus be imbued with a green hue or even filtered to provide and green-black monochromatic version of the image.

Movies in the horror genre in contrast seek to create an ominous and scary atmosphere. This may for example be achieved by providing title pages comprising a simulation of blood dripping relentlessly down the screen. An overlay effect of this type can of course also be used over still image data. Another suitable overlay effects may include swirling bats flying towards the viewer. The above mentioned image masks may also be used in creating image transitions in the horror genre. Image masks suitable for this purpose may be masks that simulate knife slashes through the ‘old’ image or skull masks, for example. It may also be desirable to illuminates parts of the images as if seen in the light of a torch while leaving the rest of the image in spooky shadow. Distortion effects may also be used to twist images into horrible representations. The horror movie genre thus focuses on effects that are believed to be instantly recognisable elements of horror movies.

Effects suitable for use in the film noir/mystery genre may include title pages with a foggy/smoky background and images or title pages that appear to be lit by street lamps. Images may also be displayed as being partly illuminated by torch light, scrutinised through binoculars or examined through a moving magnifying glass. Text may be displayed in this genre using a ransom note style text and/or so that letters of text appear in synch with the sound of the tapping of typewriter keys. Other text effects include question marks changing into letters and letter exploding into smoke. Effects chosen for the film noir/mystery genre are thus such as to evoke a evoke an atmosphere of mystery and suspense.

In the thriller genre title pages may appear on the screen as bullet holes with letters arriving in synch with the sound of gunfire. Text can also be shown in ransom note style. The shooting of on screen image data so that holes appear ‘through’ them may also be simulated along with the sound of gunfire. In summary, the thriller genre focuses on the use of effects that evoke feelings of action and adventure.

The silent movie genre may use title pages and caption pages interspersed between movie scenes with black backgrounds and decorative surrounds reminiscent of old silent movies. Images may mainly be shown mainly in sepia tones and the quality of the images is altered to give it a vintage ‘old film’ appearance. Individual captions may play on black screens before the images show rather than on the images themselves. It is noted that in all of the other genres the captions may be applied to the images themselves. The movies may play to a background of projector noise and the choice of soundtracks such as Limehouse Rag, Flap Happy, Silent Movie—Chase and Silent Movie—Heartbreak may consolidate the movie genre outcome. Effects for use in the silent movie genre are thus selected to create a nostalgic feel.

The rock music genre is designed to offer a strong relationship between background sound and the displayed images. This is achieved by causing the images to move in synch to the beat of the soundtrack. Sound waves and sound bars may be overlaid across the title pages and the images themselves, replicating the beat of the music graphically. A guitar or a lightning bolt graphic acts as a transition from one image to the next.

In the romance genre effects commonly associated with unashamedly romantic movies are employed. For example text, such as titles may explode into hearts, sparkles may be caused to fly from such text or the hearts and heart masks may be used to initiate the transition from one image to another. In another image transition the screen may be quartered and an image may be shown suffused with pink in two quarters, while being displayed using its original colours in the other two quarters. Images may be shown in soft focus.

Movie in the home movie genre may use effects intended to recreate the nostalgic experience of watching home movies flickering on living room walls, thereby attempting to recreate a homage to Super 8 film and the childhood home movie viewing experience of those born in the 60s and early 70s. Movies shot in the Home Movie genre may, for example, feature projector noise, flickering transitions, film imperfections (‘Hair’) and colour treatments like sepia, a highly coloured 60s tint as well as a faded ‘vintage’ look in addition to the above mentioned effects intended to imbue a feeling of inexpert camera use.

The children's movie genre may use text effects featuring paintball splat text display and associated sound effects and balloons flying out of the screen may be simulated. Images may further be distorted to simulate image distortions in mirrors at a funfair. Images may also transformed into sketches where the outlines of the image subjects are traced in black, red, blue or green on a monochrome background. Image transitions may feature a block effect, where the parts of or the entire screen are momentarily taken over by a mosaic of coloured squares. The screen display may also again be quartered, wherein the same image is displayed in all four quarters, albeit with different tint in each quarter, for example red, blue, yellow and green. The children's movie genre therefore intends to replicate a carefree feel.

Movies in the documentary movie genre uses effects in an attempt to offer a reflective movie style reminiscent of television documentaries. Effects used may replicates lines of a television screen and captions may be caused to roll in at the base of the screen to evoke breaking news headlines. Images may be emphasised by splitting them into quarters, wherein the same image is displayed in each quarter, albeit with altered tones, such as black, white and blue.

In the comedy movie genre a light-hearted, fun and funny atmosphere is attempted to be created. A text effects that may be used for this purpose may include a rollercoaster text displays where the words and phrases roll up and down on the screen. Images may be stretched vertically to make them tall and thin and horizontally—to make them wide and fat and additionally may also be distorted as if viewed in a funhouse mirror. Images may also be transformed into sketches where the outlines of the image subjects are traced in colour, such as black, red, blue or green, preferably on a monochrome or white background. Intense colouration may also be applied to enhance the comic mood. The quartering of the screen display discussed above with reference to the children's genre is also incorporated into this genre. Image transitions may be facilitated by simulating an image nudging another image off screen and out of view.

It will be appreciated that the above discussed effects are mere examples of effects that may be suitable for use in the associated genres. These examples are merely provided to give an indication of the type of effects that may be suitable for use in particular genres.

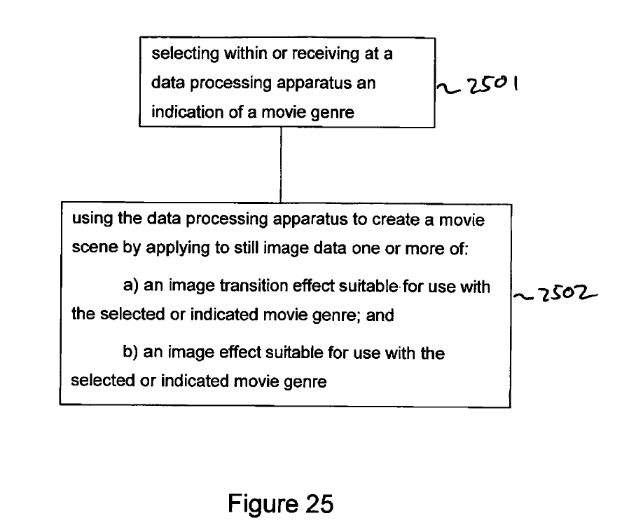

The above description relating to creating a movie based on a user's selection of the desired movie genre has been made with reference to various examples. More generally, however, a method creating a movie from one or more still images according to a preferred embodiment comprises in a first step 2501 shown in FIG. 25 the selecting within or receiving at a data processing apparatus an indication of a movie genre. In a second step 2502 the data processing apparatus is used to create a movie scene by applying to still image data one or more of:

a) an image transition effect suitable for use with the selected or indicated movie genre; and

b) an image effect suitable for use with the selected or indicated movie genre.

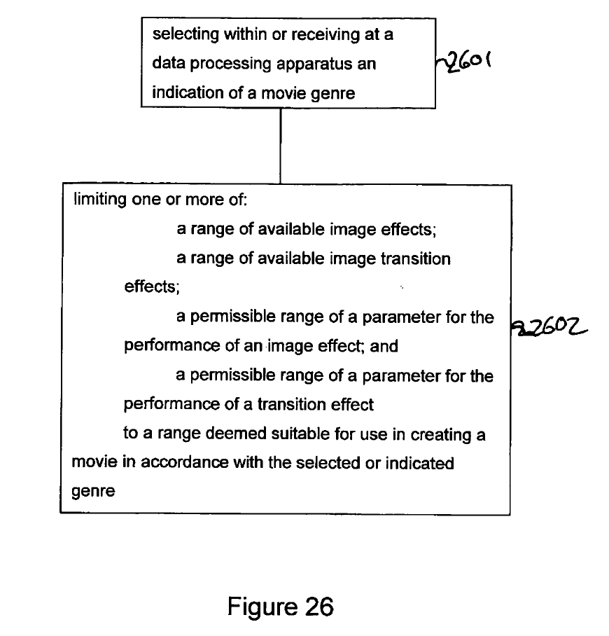

Another preferred method relates to performing a selection for use in a process of creating a movie from one or more still images as shown in FIG. 26. A first step 2601 comprises selecting within or receiving at a data processing apparatus an indication of a movie genre. A second step 2602 comprises limiting one or more of:
a range of available image effects;
a range of available image transition effects;
a permissible range of a parameter for the performance of an image effect; and
a permissible range of a parameter for the performance of a transition effect

to a range deemed suitable for use in creating a movie in accordance with the selected or indicated genre.

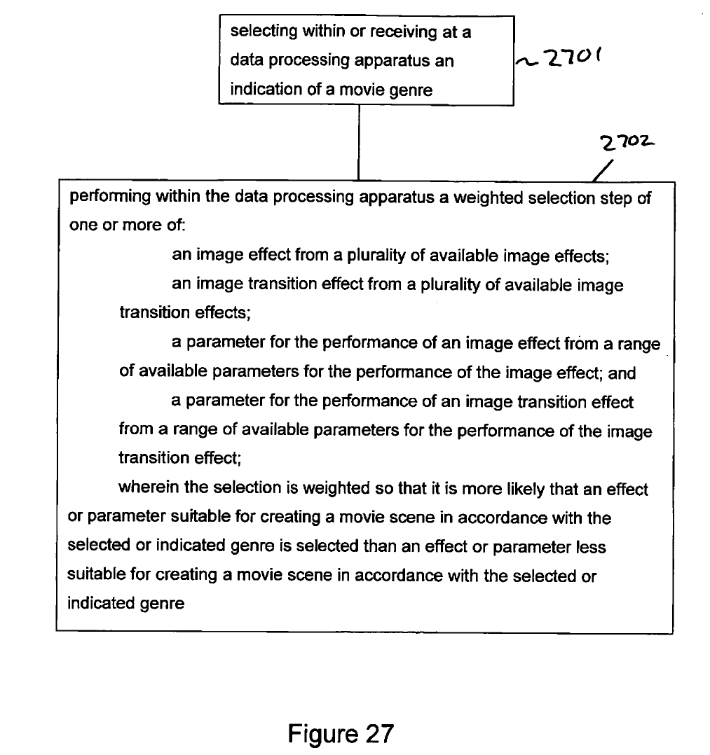

A further preferred method for performing a selection for use in a process of creating a movie from one or more still images is shown in FIG. 27. The method comprises in a first step 2701 selecting within or receiving at a data processing apparatus an indication of a movie genre. In a second step 2702 the method comprises performing within the data processing apparatus a weighted selection step of one or more of:
an image effect from a plurality of available image effects;
an image transition effect from a plurality of available image transition effects;
a parameter for the performance of an image effect from a range of available parameters for the performance of the image effect; and
a parameter for the performance of an image transition effect from a range of available parameters for the performance of the image transition effect;

wherein the selection is weighted so that it is more likely that an effect or parameter suitable for creating a movie scene in accordance with the selected or indicated genre is selected than an effect or parameter less suitable for creating a movie scene in accordance with the selected or indicated genre.

As described above, a user may be given the opportunity to alter selection of effects so that a movie may use effects preferred by the user instead of solely randomly or weighted randomly created effects. It may, however, be envisaged that a user considers a first attempt of the data processing apparatus at selecting effects in accordance with the selected genre as having lead to a largely undesirable result. In a preferred embodiment the user is given the opportunity to ‘re-shoot’ the movie. The relevant option may for example be presented to the user in the context of the user interface shown in FIG. 13 or FIG. 14. To avoid creating a second movie with a look and feel similar to the originally created movie, knowledge of effects used in the original movie discussed above in the context of ‘in movie memory’ is used in the second movie creation process to avoid the use of effects that had previously been used in the original movie.

In an alternative arrangement a ‘re-shot’ movie uses the same effects used in an originally shot movie, based on the knowledge of effects used in the original movie, but comprises a new selection of parameters governing the performance of the effects, so that the general principles underlying the appearance of the movie are retained while the look and feel of the movie is changed slightly.

A further embodiment also envisages an alternative arrangement for permitting user review of a sample movie. In the above described example a user had the choice between three degrees of permitted user interaction. The user's choice in this regard determined the degree of freedom the user was given in selecting certain movie effects and parameters, either for the entire movie or for separate scenes. In the alternative arrangement the user is permitted to edit a sample movie presented to him or her on a scene by scene basis. The user is again given a choice of the degree of interaction desired for this purpose. In this preferred embodiment the user can in particular select the scene that is to be edited (assuming that the user has not chosen to re-shoot the entire movie). The user is then presented with a selection (for example in the form of activatalbe icons on screen) of whether he or she wants an active role in determining the effect/effect(s) and parameters used in editing the movie scene or if the editing of the movie scene is to be performed automatically by the movie creator 1/movie manager 2. In the former case the user is presented with a selection of effects (for example image effects such as image movement effects and image graphic effects, overlay effects, text effects types and transition effects) and parameters governing the performance of the effects from which adequate effects and parameters can be selected by the user. In the later case the editing of the scene is based on a random selection of effects according to the selected genre. Irrespective of the user's choice, however, it is preferred for the user to be presented with the opportunity to edit opening and end messages and in particular to select background, text effect and overlay types in this context.

The present invention has been described with reference to particular preferred embodiments. This description is, however, not to be considered limiting. The above mentioned lists of image effects, transition effects and text effects are, for example, not intended to be exhaustive. Instead, the present invention can include any and all known image effects, transition effects and text effects.

The present invention is further not limited to an application on a server. The method of the invention may alternatively be performed by a computer program that resides in its entirety on a user's computer, rather than on a server, or on a hand held device capable of performing the required image manipulation routines.

It is also envisaged that user created background music could be included in the movie or that more than one piece of background music is used.

The scope of protection afforded is solely determined by the accompanying claims.

1. A method for creating a movie from one or more still images comprising:
randomly selecting, using a data processing apparatus, an image effect from a list of predetermined image effects; and
creating a movie scene in which a first portion of the still image is displayed in an initial display and in which a second portion of the still image is displayed in a later display by applying the selected image effect to create a transition between the initial display and the later display.

2. A method as claimed in claim 1, further comprising:
randomly selecting within the data processing apparatus a further image effect from a list of predetermined image effects; and
creating a further movie scene in which a portion of a still image is displayed in a further initial display and in which another portion of the still image is displayed in a further later display by applying the selected further image effect to create a transition between the further initial display and the further later display.

3. A method as claimed in claim 2, wherein the image effect and the further image effect are applied to the same still image.

4. A method as claimed in claim 1, wherein the list of predetermined image effects includes more than one of:
i. panning from the initial image portion to the further image portion;
ii. panning from the initial image portion to and beyond the further image portion and returning to the further image portion thereafter
iii. zooming within the still image;
iv. resting on the displayed image portion while applying a camera shake effect to the display of the image portion;
v. rotating a portion of the still image;
vi. applying a camera shake effect;
vii. performing a step wise zooming or panning movement;
viii. applying a blur effect;
ix. applying a blur and focus effect;
x. applying a motion blur effect;
xi. applying a fade in and fade out effect;
xii. tinting the still image;
xiii. gradually changing the colour content of the image until the entire image has a predetermined colour, such as white;
xiv. gradually converting the still image into a negative of itself;
xv. changing the still image from a colour image to a greyscale image;
xvi. changing the still image from a greyscale image to a colour image;
xvii. increasing the contrast of the image;
xviii. decreasing the contrast of the image;
xix. applying a graphics overlay over the still image;
xx. moving the entire still image or a portion thereof from a position of the first display to another position in the second display;
xxi. combinations of two or more of (i) to (xx); and
xxii. repeating one or more of (i) to (xx) plural times.

5. A method as claimed in claim 1, further comprising receiving an indication from a user of the location of a focal point in the still image, wherein one or both of the first and second portions of the still image that are to be displayed surrounds and is centred on the focal point.

6. A method as claimed in claim 1, further comprising receiving an indication from a user of the location of two focal points in the still image, wherein the first portion surrounds and is centred on one of the focal points and wherein the second portion surrounds and is centred on the other one of the focal points.

7. A method as claimed in claim 1, further comprising automatically determining all focal points that are required for the application of the image effect and for which no user indication has been received.

8. A method as claimed in claim 1, further comprising receiving an indication from a user regarding one or more of: a mood, a theme and a genre for the movie.

9. A method as claimed in claim 1, further comprising suggesting movie parameters based on a previously received indication of a user choice.

10. A method as claimed in claim 9, further comprising allowing a degree of freedom for altering the suggested movie parameters.

11. A method as claimed in claim 10, further comprising allowing changing the degree of freedom.

12. A method as claimed in claim 1, further comprising:
causing a data processing apparatus to randomly select a text effect type from a list of predetermined text effect types;
creating a text effect by applying the selected text effect type to a part or all of text received from a user or to stock text; and
overlaying the text effect on to a scene of the movie.

13. A method as claimed in claim 12, wherein the step of applying the selected text effect type comprises applying the selected text effect type to a single letter of the text.

14. A method as claimed in claim 12, further comprising receiving a user input indicating one or more of: a theme, a mood and a genre for the movie.

15. A method as claimed in claim 14, further comprising associating text effect types with one or more of: one or more moods, one or more themes and one or more genres; and only allowing selection of a text effect type if that text effect type is associated with the mood, theme or genre indicated by the user.

16. A method as claimed in claim 15, wherein a text effect type is associated with a range of possible operating parameters, the method further comprising:
associating one or more sub-ranges of the range of possible operating parameters with one or more of: one or more moods, one or more themes and one or more genres;
randomly selecting an operating parameter associated with the selected text effect type from those sub-ranges of the range of possible operating parameters that are associated with the mood, theme or genre indicated by the user.

17. A method according to claim 1, wherein said method is implemented in software.

18. A method as claimed in claim 1, further comprising randomly selecting one or more parameters associated with the selected image effect from respective one or more predetermined ranges of parameters.

19. A method as claimed in claim 18, further comprising receiving an indication from a user regarding one or more of: a mood, a theme and a genre for the movie.

20. A method as claimed in claim 19, wherein one or more of the one or more predetermined ranges of parameters are sub-ranges of respective ranges of possible parameters, and wherein the sub-ranges exclude parameters that are deemed unsuitable for use in a movie having the mood, theme or genre indicated by the user.

21. A method as claimed in claim 20, further comprising:
associating one or more sub-ranges of the range of possible parameters with one or more of: one or more moods, one or more themes and one or more genres;
wherein the step of randomly selecting an operating parameter comprises randomly selecting an operating parameter from the sub-ranges of operating parameters associated with the mood, theme or genre indicated by the user.

22. A method for creating a movie from one or more still images comprising:
randomly selecting, using a data processing apparatus, an image effect from a list of predetermined image effects; and
creating a movie scene in which a portion of a first still image is displayed in an initial display and in which a portion of a second still image is displayed in a later display by applying the selected image effect to create a transition between the initial display and the later display.

23. A method as claimed in claim 22, further comprising receiving an indication from a user of the location of a focal point in one of the first and the second image, wherein the image portion to be displayed of the one image surrounds and is centred on the focal point.

24. A method as claimed in claim 22, further comprising receiving an indication from a user of the location of a focal point in the first image and of a location of a focal point in the second image, wherein the portion in the first image surrounds and is centred on the focal point in the first image and wherein the portion in the second image surrounds and is centred on the focal point in the second image.

25. A method as claimed in claim 22, further comprising automatically determining all focal points that are required for the application of the image effect and for which no user indication has been received.

26. A method as claimed in claim 22, further comprising receiving an indication from a user regarding one or more of: a mood, a theme and a genre for the movie.

27. A method as claimed in claim 26, wherein the list of predetermined image effects comprises a part of a list of possible image effects, and wherein the list of predetermined image effects does not comprise image effects that are deemed unsuitable for use in a movie having the mood, theme or genre indicated by the user.

28. A method as claimed in claim 27, the method further comprising permitting a user to further limit the list of predetermined image effects to include only user identified desired effects, the random selection being made based on the further limited list of predetermined image effects.

29. A method as claimed in claim 28, further comprising limiting the image effects used in the movie to the image effects comprised in the further limited list of predetermined image effects, wherein for each scene of the movie one image effect from the list is randomly selected.

30. A method as claimed in claim 22, further comprising suggesting movie parameters based on a previously received indication of a user choice.

31. A method as claimed in claim 30, further comprising allowing a degree of freedom for altering the suggested movie parameters.

32. A method as claimed in claim 31, further comprising allowing changing the degree of freedom.

33. A method as claimed in claim 22, further comprising:
causing a data processing apparatus to randomly select a text effect type from a list of predetermined text effect types;
creating a text effect by applying the selected text effect type to a part or all of text received from a user or to stock text; and
overlaying the text effect on to a scene of the movie.

34. A method as claimed in claim 33, wherein the step of applying the selected text effect type comprises applying the selected text effect type to a single letter of the text.

35. A method as claimed in claim 33, further comprising receiving a user input indicating one or more of: a theme, a mood and a genre for the movie.

36. A method as claimed in claim 35, further comprising associating text effect types with one or more of: one or more moods, one or more themes and one or more genres; and only allowing selection of a text effect type if that text effect type is associated with the mood, theme or genre indicated by the user.

37. A method as claimed in claim 36, wherein a text effect type is associated with a range of possible operating parameters, the method further comprising:
associating one or more sub-ranges of the range of possible operating parameters with one or more of: one or more moods, one or more themes and one or more genres;
randomly selecting an operating parameter associated with the selected text effect type from those sub-ranges of the range of possible operating parameters that are associated with the mood, theme or genre indicated by the user.

38. A method according to claim 22, wherein said method is implemented in software.

39. A method for creating a movie from one or more still images comprising:
selecting or receiving an indication of a selected image effect;
randomly selecting, using a data processing apparatus, one or more parameters associated with the selected image effect from respective one or more predetermined ranges of parameters; and
creating a movie scene in which a first portion of the still image is displayed in an initial display and in which a second portion of the still image is displayed in a later display by applying the selected image effect based on a said randomly selected parameter to create a transition between the initial display and the later display.

40. A method as claimed in claim 39, further comprising receiving an indication from a user regarding one or more of: a mood, a theme and a genre for the movie.

41. A method as claimed in claim 40, wherein one or more of the one or more predetermined ranges of parameters are sub-ranges of respective ranges of possible parameters, and wherein the sub-ranges exclude parameters that are deemed unsuitable for use in a movie having the mood, theme or genre indicated by the user.

42. A method as claimed in claim 41, further comprising:
associating one or more sub-ranges of the range of possible parameters with one or more of: one or more moods, one or more themes and one or more genres;
wherein the step of randomly selecting an operating parameter comprises randomly selecting an operating parameter from the sub-ranges of operating parameters associated with the mood, theme or genre indicated by the user.

43. A method as claimed in claim 39, further comprising suggesting movie parameters based on a previously received indication of a user choice.

44. A method as claimed in claim 43, further comprising allowing a degree of freedom for altering the suggested movie parameters.

45. A method as claimed in claim 44, further comprising allowing changing the degree of freedom.

46. A method as claimed in claim 39, further comprising:
causing a data processing apparatus to randomly select a text effect type from a list of predetermined text effect types;
creating a text effect by applying the selected text effect type to a part or all of text received from a user or to stock text; and
overlaying the text effect on to a scene of the movie.

47. A method as claimed in claim 46, wherein the step of applying the selected text effect type comprises applying the selected text effect type to a single letter of the text.

48. A method as claimed in claim 46, further comprising receiving a user input indicating one or more of: a theme, a mood and a genre for the movie.

49. A method as claimed in claim 48, further comprising associating text effect types with one or more of: one or more moods, one or more themes and one or more genres; and only allowing selection of a text effect type if that text effect type is associated with the mood, theme or genre indicated by the user.

50. A method as claimed in claim 49, wherein a text effect type is associated with a range of possible operating parameters, the method further comprising:
associating one or more sub-ranges of the range of possible operating parameters with one or more of: one or more moods, one or more themes and one or more genres;
randomly selecting an operating parameter associated with the selected text effect type from those sub-ranges of the range of possible operating parameters that are associated with the mood, theme or genre indicated by the user.

51. A method according to claim 39, wherein said method is implemented in software.

52. A method for creating a movie from one or more still images comprising:
selecting or receiving an indication of a selected image effect;
randomly selecting, using a data processing apparatus, one or more parameters associated with the selected image effect from respective one or more predetermined ranges of parameters; and
creating a movie scene in which a portion of a first still image is displayed in an initial display and in which a portion of a second still image is displayed in a later display by applying the selected image effect based on a said randomly selected parameter to create a transition between the initial display and the later display.

53. A method as claimed in claim 52, further comprising receiving an indication from a user regarding one or more of: a mood, a theme and a genre for the movie.

54. A method as claimed in claim 53, wherein one or more of the one or more predetermined ranges of parameters are sub-ranges of respective ranges of possible parameters, and wherein the sub-ranges exclude parameters that are deemed unsuitable for use in a movie having the mood, theme or genre indicated by the user.

55. A method as claimed in claim 54, further comprising:
associating one or more sub-ranges of the range of possible parameters with one or more of: one or more moods, one or more themes and one or more genres;
wherein the step of randomly selecting an operating parameter comprises randomly selecting an operating parameter from the sub-ranges of operating parameters associated with the mood, theme or genre indicated by the user.

56. A method as claimed in claim 52, further comprising suggesting movie parameters based on a previously received indication of a user choice.

57. A method as claimed in claim 56, further comprising allowing a degree of freedom for altering the suggested movie parameters.

58. A method as claimed in claim 57, further comprising allowing changing the degree of freedom.

59. A method as claimed in claim 52, further comprising:
causing a data processing apparatus to randomly select a text effect type from a list of predetermined text effect types;
creating a text effect by applying the selected text effect type to a part or all of text received from a user or to stock text; and
overlaying the text effect on to a scene of the movie.

60. A method as claimed in claim 59, wherein the step of applying the selected text effect type comprises applying the selected text effect type to a single letter of the text.

61. A method as claimed in claim 59, further comprising receiving a user input indicating one or more of: a theme, a mood and a genre for the movie.

62. A method as claimed in claim 61, further comprising associating text effect types with one or more of: one or more moods, one or more themes and one or more genres; and only allowing selection of a text effect type if that text effect type is associated with the mood, theme or genre indicated by the user.

63. A method as claimed in claim 62, wherein a text effect type is associated with a range of possible operating parameters, the method further comprising:
associating one or more sub-ranges of the range of possible operating parameters with one or more of: one or more moods, one or more themes and one or more genres;
randomly selecting an operating parameter associated with the selected text effect type from those sub-ranges of the range of possible operating parameters that are associated with the mood, theme or genre indicated by the user.

64. A method according to claim 52, wherein said method is implemented in software.

65. A method for creating a movie from one or more still images comprising:
receiving an indication from a user regarding one or more of a mood,
a theme and a genre for the movie;
randomly selecting, using a data processing apparatus, an image effect from a list of predetermined image effects; and
creating a movie scene in which a first portion of the still image is displayed in an initial display and in which a second portion of the still image is displayed in a later display by applying the selected image effect to create a transition between the initial display and the later display;
wherein each predetermined image effect is associated with an indication of one or more of: one or more moods, one or more themes and one or more genres; and
wherein said selection does not select image effects that do not comprise an indication of a mood, theme or genre corresponding to the mood, theme or genre indicated by the user.

66. A method for creating a movie from one or more still images comprising:
receiving an indication from a user regarding one or more of a mood,
a theme and a genre for the movie;
selecting or receiving an indication of a selected image effect;
randomly selecting, using a data processing apparatus, one or more parameters associated with the selected image effect from respective one or more predetermined ranges of parameters; and
creating a movie scene in which a first portion of the still image is displayed in an initial display and in which a second portion of the still image is displayed in a later display by applying the selected image effect based on the selected parameters to create a transition between the initial display and the later display;
wherein each predetermined range of parameters is associated with an indication of one or more of: one or more moods, one or more themes and one or more genres; and
wherein said selection does not select parameters from predetermined ranges of parameters that do not comprise an indication of a mood, theme or genre corresponding to the mood, theme or genre indicated by the user.

67. A method according to 66, wherein said method is implemented in software.

68. A method for creating a movie from one or more still images comprising:
receiving an indication from a user regarding one or more of a mood,
a theme and a genre for the movie;
randomly selecting, using a data processing apparatus, an image effect from a list of predetermined image effects; and
creating a movie scene in which a portion of a first still image is displayed in an initial display and in which a portion of a second still image is displayed in a later display by applying the selected image effect based on the selected parameters to create a transition between the initial display and the later display;
wherein each predetermined range of parameters is associated with an indication of one or more of: one or more moods, one or more themes or one or more genres; and
wherein said selection does not select parameters from predetermined ranges of parameters that do not comprise an indication of a mood, theme or genre corresponding to the mood, theme or genre indicated by the user.

69. A method according to claim 68, wherein said method is implemented in software.

70. A method for creating a movie from one or more still images comprising:
receiving an indication from a user regarding one or more of a mood,
a theme and a genre for the movie;
selecting or receiving an indication of a selected image effect;
randomly selecting within a data processing apparatus one or more parameters associated with the selected image effect from respective one or more predetermined ranges of parameters; and
creating a movie scene in which a portion of a first still image is displayed in an initial display and in which a portion of a second still image is displayed in a later display by applying the selected image effect based on the selected parameters to create a transition between the initial display and the later display;
wherein each predetermined range of parameters is associated with an indication of one or more of: one or more moods, one or more themes or one or more genres; and
wherein said selection does not select parameters from predetermined ranges of parameters that do not comprise an indication of a mood, theme or genre corresponding to the mood, theme or genre indicated by the user.

71. A method according to claim 70, wherein said method is implemented in software.

72. A method for creating a movie from one or more still images comprising:
randomly selecting, using a data processing apparatus, an image effect from a list of predetermined image effects; and
creating a movie scene by applying the selected image effect to create a transition between an initial display and a subsequent display, each of the initial display and the subsequent display comprising a portion of a still image that is to be displayed in the scene.

73. A method according to claim 72, wherein said method is implemented in software.

74. A device for creating a movie from one or more still images comprising:
a collection of data processing stages, each said data processing stage arranged for applying an associated image effect to image data;
a selector for randomly selecting a data processing stage from the collection of data processing stages; and
an image data processor arranged to apply the selected data processing stage to still image data to create a movie scene.

75. A device as claimed in claim 74, wherein the collection of data processing stages includes more than one of:
(i) a stage arranged to sequentially display portions of the still image so as to simulate a panning between image portions;
(ii) a stage arranged to sequentially display portions of the still image so as to simulate a panning from the initial image portion to and beyond the further image portion and returning to the further image portion thereafter;
(iii) a stage arranged to display all of the still image in a first position in a first display and all of the still image in a second position in a second display;
(iv) a stage arranged to sequentially display portions of the still image so as to simulate a zooming within the still image;
(v) a stage arranged to sequentially display portions of the still image so as to simulate resting on the scene with an unsteady camera;
(vi) a stage arranged to sequentially display a portion of the still image so as to rotate the portion in the display;
(vii) a stage arranged to sequentially display portions of the still image so as to simulate a camera shake effect;
(viii) a stage arranged to sequentially display portions of the still image so as to simulate a step wise zooming or panning movement;
(ix) a stage arranged to sequentially display a portion of the still image while increasing the amount of blur of the portion;
(x) a stage arranged to sequentially display a portion of the still image while first increasing and thereafter reducing the amount of blur of the portion;
(xi) a stage arranged to sequentially display a portion of the still image while changing the displayed portions in a manner that simulates a motion blur effect;
(xii) a stage arranged to sequentially display a portion or all of the still image while gradually increasing the amount of a particular colour, for example red, contained in the portions so as to tint the image;
(xiii) a stage arranged to sequentially display a portion or all of the still image while gradually altering the colour content of the portion or all of the still image until the portion or all of the still image comprises only a single colour, for example white;
(xiv) a stage arranged to sequentially display a portion or all of the still image while gradually converting the portion or all of still image into a negative of itself;
(xv) a stage arranged to sequentially display a portion or all of the still image while changing the portion or all of the still image from a colour image to a greyscale image;
(xvi) a stage arranged to sequentially display a portion or all of the still image while changing the portion of all of the still image from a greyscale image to a colour image;
(xvii) a stage arranged to sequentially display a portion or all of the still image while increasing the contrast of the portion or all of the still image;
(xviii) a stage arranged to sequentially display a portion or all of the still image while decreasing the contrast of the portion or all of the still image;
(xix) a stage arranged to a portion of a still image while applying or moving an overlay feature to the portion of the still image;
(xx) a stage arranged to sequentially display a portion or all of the still image while gradually fading a portion of a still image out and thereafter fading the portion in;
(xxi) a stage arranged to sequentially display a portion or all of the still image so as to generate an effect that is a combination of two or more of the effects generated by the stages of (i) to (xx); and
(xxii) a stage arranged create an effect that is a repetition of the effects generated by one or more of the stages of (i) to (xx).

76. A device as claimed in claim 74, further comprising a receiver for receiving an indication from a user of the location of a focal point in the still image, the selected data processing stage arranged to cause the image data processor to apply the selected data processing stage to a portion of the still image that surrounds and is centred on the location of a focal point received with an indication from a user.

77. A device as claimed in claim 74, further comprising a receiver for receiving an indication from a user of one or more of: a mood, a theme and a genre for the movie.

78. A device as claimed in claim 77, wherein each data processing stage comprises an indication of one or more of: one or more moods, one or more themes and one or more genres for which the data processing stage is suited, and wherein the random selector is arranged not to select data processing methods not having an indication corresponding to a received indication of a desired mood, theme or genre.

79. A device as claimed in claim 74, wherein the random selector is further arranged to randomly select one or more parameters associated with the selected data processing stage from respective one or more predetermined ranges of parameters.

80. A device as claimed in claim 79, further comprising a receiver for receiving an indication from a user regarding one or more of a mood, a theme and a genre for the movie.

81. A device as claimed in claim 80, wherein the one or more predetermined ranges of parameters comprise sub-ranges, each sub-range comprising an indication of one or more of: one or more moods, one or more themes and one or more genres for which the sub-range is suited, and wherein the random selector is arranged not to select sub-ranges of a predetermined range of parameters that do not comprise an indication of a mood, theme or genre corresponding to a mood, theme or genre received in a user indication.

82. A device as claimed in claim 74, further comprising a parameter suggester arranged to suggest movie parameters based on received indications of previous user choices.

83. A device as claimed in claim 82, further comprising a limiter arranged to limit the degree of freedom available for altering the suggested movie parameters.

84. A device as claimed in claim 83, wherein the limiter is arranged for receiving an indication of the degree to which the freedom to alter the movie parameters is to be limited and further arranged to change the degree of freedom based on a said received indication.

85. A device as claimed in claim 74, further comprising a collection of text data processing stages, each said text data processing stage arranged for applying an associated image text effect to text data;
wherein the selector is further arranged to randomly select a text data processing stage from the collection of text data processing stage; and
wherein the image data processor is further arranged to apply the selected text data processing stage to text data to create a text image effect and to overlay the text image effect on to a scene of the movie.

86. A device as claimed in claim 85, wherein the collection of text data processing stages comprises one or more text data processing stages arranged to cause the image data processor in use to act on an independent letter of a text.

87. A device as claimed in claim 86, further comprising a receiver for receiving a user input indicating one or more of a mood, a theme and a genre for the movie.

88. A device as claimed in claim 87, wherein each text data processing stage comprises an indication of one or more of: one or more moods, one or more themes and one or more genres for which the text data processing stage is suited and wherein the selector is arranged not to select a text data processing stage that is not associated with an indication of a suitable mood, theme or genre that corresponds to a received indication of mood, theme or genre.

89. A device as claimed in claim 88, wherein a said text data processing stage comprises a range of possible operating parameters, the range of possible operating parameters comprises one or more sub-ranges, each sub-range comprising an indication of one or more of: one or more moods, one or more themes or one or more genres for which the sub-range is suited;
wherein the selector is arranged not to select a sub-range of parameters that is not associated with an indication of a suitable mood, theme or genre that corresponds to a received indication of mood, theme or genre.

90. A device for creating a movie from one or more still images comprising:
a data processing stage arranged for applying an associated image effect to still image data;
a selector for randomly selecting one or more parameters associated with the data processing stage from respective one or more predetermined ranges of parameters; and
an image data processor arranged to apply the data processing stage based on the selected parameters to still image data to create a movie scene.

91. A device as claimed in claim 90, further comprising a receiver for receiving an indication from a user regarding one or more of a mood, a theme and a genre for the movie.

92. A device as claimed in claim 91, wherein the one or more predetermined ranges of parameters comprise sub-ranges, each sub-range comprising an indication of one or more of: one or more moods, one or more themes and one or more genres for which the sub-range is suited, and wherein the random selector is arranged not to select sub-ranges of a predetermined range of parameters that do not comprise an indication of a mood, theme or genre corresponding to a mood, theme or genre received in a user indication.

93. A method for creating a movie from one or more still images comprising:
selecting within or receiving at a data processing apparatus an indication of a movie genre; and
using the data processing apparatus to create a movie scene by applying to still image data one or more of:
a) an image transition effect suitable for use with the selected or indicated movie genre; and
b) an image effect suitable for use with the selected or indicated movie genre.

94. A method as claimed in claim 93, wherein a plurality of image transitions and/or image effects are available to the data processing apparatus;
wherein one or more genres are associated with one or more of the image effects and image transition effects; and
wherein in the step of creating a movie scene only image effects and/or image transition effects that are associated with the selected or indicated genre are applied.

95. A method as claimed in claim 94, further comprising the step of creating a further movie scene, wherein a further image effect or a further image transition effect associated with the selected or indicated genre is applied; and
wherein said further image effect and/or image transition effect is selected such that repeated use of the effect within the movie is prevented.

96. A method as claimed in claim 93, wherein said step of creating a movie scene comprises selecting an image effect and/or an image transition effect, wherein said selection is a weighted selection.

97. A method as claimed in claim 96, wherein for a predetermined genre one or more of said image transition effects and/or image effects are associated with a maximum desired use per unit duration of the movie.

98. A method as claimed in claim 97, wherein said selection is weighted so as to minimise the likelihood that the use of the image transition effect and/or image effect per unit duration of the movie exceeds said maximum desired use.

99. A method as claimed in claim 93, wherein the operation of an image effect and/or a transition effect is at least partially defined by an operating parameter having a range, wherein a sub-range of said range is not deemed suitable for use in creating a movie for a predetermined genre; and
wherein in the step of creating a movie scene for the predetermined genre the image effect and/or transition effect is applied based on a selection of the operating parameters from outside the sub-range.

100. A method as claimed in claim 93, wherein a plurality of image transitions and/or image effects are available to the data processing apparatus; and
wherein information is stored in the data processing apparatus indicating a first image effect and/or image transition effect that should not be applied to still image data consecutively and/or simultaneously with an also indicated second image effect and/or image transition effect.

101. A method for performing a selection for use in a process of creating a movie from one or more still images comprising:
selecting within or receiving at a data processing apparatus an indication of a movie genre;
limiting one or more of:
a range of available image effects;
a range of available image transition effects;
a permissible range of a parameter for the performance of an image effect; and
a permissible range of a parameter for the performance of a transition effect
to a range deemed suitable for use in creating a movie in accordance with the selected or indicated genre.

102. A method as claimed in claim 101, further comprising creating a movie scene from still image data based on an image effect and/or an image transition effect selected from a said limited range of available image effects and/or available transition effects.

103. A method as claimed in claim 101, further comprising creating a movie scene from still image data based on an image effect and/or an image transition effect operated using a parameter selected from a said limited permissible range of said parameter.

104. A method as claimed in claim 101, further comprising storing an indication of the suitability of an image effect and/or an image transition effect for use in creating a movie in a predetermined movie genre.

105. A method as claimed in claim 101, further comprising storing an indication of the suitability of a sub-range of said permissible range of a parameter for the performance of an image effect or of a sub-range of said permissible range of a parameter for the performance of an image transition effect for use in creating a movie in a predetermined movie genre.

106. A method for performing a selection for use in a process of creating a movie from one or more still images, the method comprising:
selecting within or receiving at a data processing apparatus an indication of a movie genre;
performing within the data processing apparatus a weighted selection step of one or more of:
an image effect from a plurality of available image effects;
an image transition effect from a plurality of available image transition effects;
a parameter for the performance of an image effect from a range of available parameters for the performance of the image effect; and
a parameter for the performance of an image transition effect from a range of available parameters for the performance of the image transition effect;
wherein the selection is weighted so that it is more likely that an effect or parameter suitable for creating a movie scene in accordance with the selected or indicated genre is selected than an effect or parameter less suitable for creating a movie scene in accordance with the selected or indicated genre.

107. A method according to claim 106, further comprising storing for each of the plurality of image effects or the plurality of image transition effects a weighting factor indicating the suitability of use of the image or image transition effect in creating a movie scene in accordance with a genre;
wherein the step of performing a weighted selection uses the weighting factor associated with the image or image transition effects and with the selected or received genre for determining an image or image transition effect to be used in creating the movie scene.

108. A method according to claim 107, wherein said stored weighting factor is approximately zero or zero if said given image or transition effect is not deemed suitable for use in creating a movie scene in accordance with the genre the weighting factor relates to.

109. A method according to claim 106, wherein a said parameter is selected from a range of available parameters, the method further compromising storing for one or more genres weighting factor information indicating the suitability of said range or of one or more sub-ranges of said range for use in creating a movie scene in accordance with the genre the weighting factor information is stored for.

110. A method according to claim 109, wherein said weighting factor is approximately zero if said range or one or more of said sub-ranges are not deemed suitable for use in creating a movie scene in accordance with the genre the weighting factor relates to.

111. A data processing apparatus arranged to perform a selection, the selection intended for use in creating a movie scene from still image data, the apparatus arranged to receive an indication of a movie genre;
the apparatus comprising a selector arranged to automatically select one or more of:
an image effect suitable for use in creating a movie scene in accordance with the received indication of movie genre from a plurality of available image effects;
an image transition effect suitable for use in creating a movie scene in accordance with the received indication of movie genre from a plurality of available image transition effects;
a parameter suitable for the performance of an image effect in accordance with the received indication of movie genre from a range of available parameters for the performance of the image effect; and
a parameter suitable for the performance of an image transition effect in accordance with the received indication of movie genre from a range of available parameters for the performance of the image transition effect.

112. An apparatus as claimed in claim 111, further storing information indicating which ones of the available image effects and/or image transition effects are suitable for use in creating a movie in accordance with a predetermined genre or with predetermined genres;
wherein said selector is arranged to select only from image effects and/or image transition effects indicated as being suitable for use in creating a movie scene in accordance with the received indication of a genre.

113. An apparatus as claimed in claim 111, further storing information indicating one or more sub-ranges of the range of available parameters for the performance of the image effect and/or the image transition effect, the indicated sub-ranges being deemed suitable for use in creating a movie in accordance with a predetermined genre or with predetermined genres;
wherein said selector is arranged to select said parameter only from a sub-range or sub-ranges indicated as being suitable for creating a movie scene in accordance with the received indication of a genre.

114. An apparatus as claimed in claim 111, further storing for one or more available movie genres information regarding a maximum desired use of one or more of the plurality of available image effects and/or image transition effects;
wherein said selector is arranged to perform a weighted selection of an image effect and/or image transition effect using the stored information associated with the received indication of a genre as weighting factors.

115. An apparatus for creating a movie scene from still image data, the apparatus comprising the apparatus claimed in claim 111 and further arranged to create a movie scene based on the still image data and on an output of said selector.
